(19) United States
(12) Patent Application Publication
(10) Pub. No.: US 2025/0086600 A1
(43) Pub. Date: Mar. 13, 2025

(54) METHOD FOR DETERMINING SPECIFIC EVENT TO BE PERFORMED ON CONTENT BASED ON RESULTS OF VOTES OBTAINED THROUGH STAKING OF SECONDARY STAKABLE TOKENS ACQUIRED BY STAKING PRIMARY STAKABLE TOKENS AND CONTENT PROVIDING SERVER USING THE SAME

(71) Applicant: Wemade Co., Ltd., Seongnam-si (KR)

(72) Inventor: Moheon SONG, Seoul (KR)

(21) Appl. No.: 18/390,836

(22) Filed: Dec. 20, 2023

(30) Foreign Application Priority Data
Sep. 7, 2023 (KR) 1020230119292

(51) Int. Cl. G06Q 20/06; H04L 9/08; H04L 9/32

(52) U.S. Cl. CPC G06Q 20/065; H04L 9/0825; H04L 9/3236; H04L 9/3247; G06Q 2220/00; G06Q 2230/00

(57) ABSTRACT

A method for determining a specific event to be performed on a content based on results of votes obtained through staking of secondary stakable tokens having been acquired by staking primary stakable tokens is provided. The method includes steps of: a content providing server (a) receiving voting request information from a user terminal; (b) (i) verifying a user signature value included in the voting request information (ii) acquiring a hashed user signature value by hashing the user signature value, and (iii) acquiring a validator signature value by signing the hashed user signature value with a validator private key; and (c) transmitting voting transaction information, including the user signature value and the validator signature value, to a management server, and then receiving a voting result corresponding to the voting transaction information from the management server, to thereby transmit the voting result to the user terminal.

### CROSS REFERENCE OF RELATED APPLICATION

This present application claims the benefit of the earlier filing date of Korean non-provisional patent application No. 10-2023-0119292, filed on Sep. 7, 2023, the entire contents of which being incorporated herein by reference.

### FIELD OF THE DISCLOSURE

The present disclosure relates to a method for determining a specific event to be performed on a content based on results of votes obtained through staking of secondary stakable tokens having been acquired by staking primary stakable tokens and a content providing server using the same; and more particularly, to the method for creating a blockchain-based content providing environment by generating, modifying and activating an agenda for a user's voting participation, and for enabling the user to directly participate in setting a content event by voting tokens on a specific agenda, and the content providing server using the same.

### BACKGROUND OF THE DISCLOSURE

Blockchain technology has garnered a great deal of attention recently and is having an impact on various industries. Amid such a trend, one industry where the blockchain technology has received great attention in recent years is a content industry. NFTs (Non-Fungible Tokens), a blockchain technology that proves the authenticity of digital assets, can be used for contents as collectable various items. Also, through a combination of the content and coins or tokens, a P2E (PLAY TO EARN) content, i.e., a content that allows users to earn virtual currencies and exchange them for real currencies, has emerged.

In addition, it is possible that the blockchain contents may also change consumer trends. With the use of NFTs, sovereignty of content items is transferred from content companies to consumers, which is a huge step forward in terms of improving the rights of the consumers who enjoy the contents. Conventionally, on the contrary, the content companies own characters and items raised by the users and merely lend them to the users.

While consumer rights have made great progress due to the development of the blockchain contents, no system has yet been implemented that allows the consumers to directly participate in determining the direction of the development of the blockchain contents and lead the blockchain contents themselves.

As such, there is a need for a technology that enables the creation of a blockchain-based content delivery environment through the generation, the modification and the activation of agendas for the participation of the consumers, i.e., the users, and that enables the users to directly participate in setting content events by voting tokens for the specific agenda.

Therefore, an enhanced method for solving the aforementioned problems is required.

### SUMMARY OF THE DISCLOSURE

It is an object of the present disclosure to solve all the aforementioned problems.

It is another object of the present disclosure to allow users to stake primary stakable tokens to obtain secondary stakable tokens as reward tokens, allow the users to perform votes on which hardware sector a specific agenda will be applied to by staking the secondary stakable tokens and provide a content by having the specific agenda applied to a specific hardware sector determined by the votes, thereby allowing the users who are interested in the specific agenda related to the content to gather in the specific hardware sector and increasing an energy efficiency of hardware.

It is still another object of the present disclosure to verify information about the user in response to a voting request for the secondary stakable tokens from a user terminal, to generate and transmit voting transaction information to a blockchain intermediary server upon completion of verifying the information about the user, and to transmit a voting result corresponding to the voting transaction information to the user terminal.

It is still yet another object of the present disclosure to transmit specific agenda generation transaction information and specific sector generation transaction information to the blockchain intermediary server in response to requests for generating the specific agenda and a specific sector corresponding thereto from a content providing server and thus transmit a specific agenda generation result and a specific sector generation result to the content providing server.

It is still yet another object of the present disclosure to transmit specific agenda execution transaction information and specific agenda cancellation transaction information to the blockchain intermediary server in response to requests for executing and cancelling the specific agenda from the content providing server and thus transmit a specific agenda execution result and a specific agenda cancellation result to the content providing server.

It is still yet another object of the present disclosure to transmit sector change transaction information and specific sector deactivation transaction information to the blockchain intermediary server in response to requests for changing and deactivating the specific sector from the content providing server and thus transmit a sector change result and a specific sector deactivation result to the content providing server.

In accordance with one aspect of the present disclosure, there is provided a method for determining a specific event to be performed on a content based on results of votes obtained through staking of secondary stakable tokens having been acquired by staking primary stakable tokens, including steps of: (a) on condition that (i) a management server has transmitted a user wallet address, a voting contract address and a first user nonce value to a user terminal in response to a voting request received from the user terminal, the voting request having been generated through the user terminal by staking the secondary stakable tokens, (ii) the user terminal has transmitted voting message signing request information, including the voting contract address, the user wallet address, a specific agenda ID, a specific sector index corresponding to a specific agenda, a voted quantity of the secondary stakable tokens and the first user nonce value, to the management server, wherein the specific sector index is an index value corresponding to a specific sector, among a 1-st sector to an n-th sector, on which a user of the user terminal intends to vote, and then (iii) the management server has transmitted a first user signature value, generated by signing the voting message signing request information with a user private key, to the user terminal, receiving, by a content providing server, voting request information, including the voting contract address, the user wallet address, the specific agenda ID, the specific sector index, the voted quantity of the secondary stakable tokens, the first user nonce value and the first user signature value, from the user terminal; (b) (i) verifying, by the content providing server, the first user signature value included in the voting request information acquired from the user terminal, (ii) acquiring, by the content providing server, a hashed first user signature value by hashing the first user signature value upon completion of the process of verifying the first user signature value, and (iii) acquiring, by the content providing server, a first validator signature value by signing the hashed first user signature value with a validator private key; and (c) transmitting, by the content providing server, voting transaction information, including the specific agenda ID, the user wallet address, the specific sector index, the voted quantity of the secondary stakable tokens, the first user nonce value, the first user signature value and the first validator signature value, to the management server, and then receiving, by the content providing server, a voting result corresponding to the voting transaction information from the management server, to thereby transmit the voting result to the user terminal.

As one example, the secondary stakable tokens are reward tokens provided to the user by staking the primary stakable tokens, and wherein, before the step of (a), the method further includes a step of: (a0) (i) on condition that (1) the management server has transmitted the user wallet address to the user terminal in response to a staking request for the primary stakable tokens from the user terminal, (2) the content providing server has transmitted first use permission request transaction information to be used for requesting permission to use the primary stakable tokens to the management server and then the management server has transmitted first hashed use permission request transaction information, generated by hashing the first use permission request transaction information, to the content providing server, (3) the content providing server has transmitted first staking request transaction information to the management server and then the management server has transmitted first hashed staking request transaction information, generated by hashing the first staking request transaction information, to the content providing server, and (4) the content providing server has transmitted the first hashed use permission request transaction information and the first hashed staking request transaction information to the user terminal, instructing, by the content providing server, the management server to (i-1) receive a signing request on the first hashed use permission request transaction information and the first hashed staking request transaction information, (i-2) generate a first specific user signature value by signing the first hashed use permission request transaction information and the first hashed staking request transaction information with a specific user key, and (i-3) transmit the first specific user signature value to the user terminal; (ii) on condition that (1) the user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the management server, instructing, by the content providing server, the management server to invoke a token management contract and execute a token use permission request function whose parameters include a token staking contract address and a staking quantity of the primary stakable tokens, to thereby receive primary stakable token use permission request processing information and transmit the primary stakable token use permission request processing information to the content providing server; (iii) on condition that the content providing server has transmitted second staking request transaction information, including the first hashed staking request transaction information and the first specific user signature value, to the management server, instructing, by the content providing server, the management server to invoke a token staking contract and execute a token staking function whose parameters include the staking quantity of the primary stakable tokens, to thereby receive primary stakable token staking processing information and transmit the primary stakable token staking processing information to the content providing server; and (iv) (iv-1) determining, by the content providing server, a quantity of the secondary stakable tokens to be distributed to the user terminal by referring to the primary stakable token staking processing information and (iv-2) granting, by the content providing server, a voting right for the specific event to be performed on the content to the user terminal by referring to a staking quantity of the secondary stakable tokens.

As another example, the secondary stakable tokens are reward tokens given to the user by staking a-th primary stakable tokens and b-th primary stakable tokens, both of which are among the first primary tokens, and wherein, before the step of (a), the method further includes a step of: (a1) (i) on condition that (1) the management server has transmitted the user wallet address to the user terminal in response to a staking request for at least one of the primary stakable tokens among the a-th primary stakable tokens and the b-th primary stakable tokens from the user terminal, (2) the content providing server has transmitted first use permission request transaction information to be used for requesting permission to use the primary stakable tokens to the management server and then the management server has transmitted first hashed use permission request transaction information, generated by hashing the first use permission request transaction information, to the content providing server, (3) the content providing server has transmitted first staking request transaction information to the management server and then the management server has transmitted first hashed staking request transaction information, generated by hashing the first staking request transaction information, to the content providing server, and (4) the content providing server has transmitted the first hashed use permission request transaction information and the first hashed staking request transaction information to the user terminal, instructing, by the content providing server, the management server to (i-1) receive a signing request on the first hashed use permission request transaction information and the first hashed staking request transaction information from the user terminal, (i-2) generate a first specific user signature value by signing the first hashed use permission request transaction information and the first hashed staking request transaction information with a specific user key, and (i-3) transmit the first specific user signature value to the user terminal; (ii) on condition that (1) the user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the management server, instructing, by the content providing server, the management server to invoke a token management contract and execute a token use permission request function whose parameters include a token staking contract address and a staking quantity of the primary stakable token, to thereby receive primary stakable token use permission request processing information and transmit the primary stakable token use permission request processing information to the content providing server; (iii) on condition that the content providing server has transmitted second staking request transaction information, including the first hashed staking request transaction information and the first specific user signature value, to the management server, instructing, by the content providing server, the management server to invoke a token staking contract and execute a token staking function whose parameters include the staking quantity of the primary stakable token, to thereby receive primary stakable token staking processing information and transmit the primary stakable token staking processing information to the content providing server; and (iv) (iv-1) determining, by the content providing server, a quantity of the secondary stakable tokens to be distributed to the user terminal by referring to the primary stakable token staking processing information and (iv-2) granting, by the content providing server, a voting right for the specific event to be performed on the content to the user terminal by referring to a staking quantity of the secondary stakable tokens.

As another example, at the step of (a), the method further includes a step of: (a2) on condition that the management server has transmitted the user wallet address, linked to the user terminal, to the user terminal in response to receiving the voting request from the user terminal, (i) receiving, by the content providing server, request information for the voting contract address from the user terminal, (ii) transmitting, by the content providing server, the request information for the voting contract address to the management server and receiving, by the content providing server, the voting contract address corresponding to the request information from the management server to transmit the voting contract address to the user terminal, and (iii) on condition that the first user nonce value corresponding to the voting contract has been transmitted to the user terminal in response to a request for the first user nonce value from the user terminal, instructing, by the content providing server, the user terminal to generate the voting message signing request information, including the voting contract address, the user wallet address, the specific agenda ID, the specific sector index corresponding to the specific agenda, the voted quantity of the secondary stakable tokens and the first user nonce value.

As another example, before the step of (a2), the method further includes a step of: (a01) the content providing server (i) (i-1) receiving a specific agenda generation contract address from the management server by requesting information on the specific agenda generation contract address, corresponding to the specific agenda, to the management server and (i-2) receiving a previous agenda ID, which is most recently generated by requesting the previous agenda ID from the management server, (ii) (ii-1) generating specific agenda generation request message information, including the specific agenda generation contract address, the previous agenda ID, specific agenda generation purpose information corresponding to the specific agenda, a minimum voting quantity of the secondary stakable tokens, cool time information corresponding to the specific agenda and cancel lock information corresponding to the specific agenda, and (ii-2) acquiring hashed specific agenda generation request message information from the management server by requesting hashing of the specific agenda generation request message information to the management server, and (iii) (iii-1) acquiring a second validator signature value by signing the hashed specific agenda generation request message information with the validator private key and (iii-2) transmitting specific agenda generation transaction information, including the specific agenda generation purpose information, the minimum voting quantity of the secondary stakable tokens, the cool time information, the cancel lock information and the second validator signature value, to the management server to thereby receive a specific agenda generation result corresponding to the specific agenda generation transaction information from the management server.

As another example, the method further includes a step of: (a02) the content providing server (i) (i-1) receiving a specific sector generation contract address from the management server by requesting information on the specific sector generation contract address, corresponding to the specific sector index, to the management server and (i-2) receiving a first validator nonce value and the specific agenda ID by requesting the first validator nonce value and the specific agenda ID from the management server, (ii) (ii-1) generating specific sector generation request message information, including the specific sector generation contract address, the specific agenda ID, the first validator nonce value, specific sector generation purpose information and a specific sector account address, and (ii-2) acquiring hashed specific sector generation request message information from the management server by requesting hashing of the specific sector generation request message information to the management server, and (iii) (iii-1) acquiring a third validator signature value by signing the hashed specific sector generation request message information with the validator private key and (iii-2) transmitting specific sector generation transaction information, including the specific agenda ID, the first validator nonce value, the specific sector generation purpose information, the specific sector account address and the third validator signature value, to the management server to thereby receive a specific sector generation result corresponding to the specific sector generation transaction information from the management server.

As another example, at the step of (a02), in order to change the specific sector to which the specific agenda is applied to another sector, the method further includes a step of: the content providing server (i) (i-1) receiving a sector change contract address from the management server by requesting information on the sector change contract address to the management server and (i-2) receiving a second validator nonce value and the specific agenda ID by requesting the second validator nonce value and the specific agenda ID from the management server, (ii) (ii-1) generating sector change request message information, including the sector change contract address, the specific agenda ID, the second validator nonce value, another sector index corresponding to the another sector, sector change purpose information and another sector account address corresponding to the another sector, and (ii-2) acquiring hashed sector change request message information from the management server by requesting hashing of the sector change request message information to the management server and (iii) (iii-1) acquiring a fourth validator signature value by signing the hashed sector change request message information with the validator private key and (iii-2) transmitting sector change transaction information, including the specific agenda ID, the second validator nonce value, the sector change purpose information, the another sector index, the another sector account address and the fourth validator signature value, to the management server to thereby receive a sector change result corresponding to the sector change transaction information from the management server.

As another example, the method further includes a step of: (d) in order to deactivate the specific sector, the content providing server (i) (i-1) requesting information on a specific sector deactivation contract address corresponding to the specific sector index to the management server to thereby receive the specific sector deactivation contract address and (i-2) receiving a third validator nonce value and the specific agenda ID by requesting the third validator nonce value and the specific agenda ID from the management server, (ii) (ii-1) generating specific sector deactivation request message information, including the specific sector deactivation contract address, the specific agenda ID, the specific sector index and the third validator nonce value, and (ii-2) acquiring hashed specific sector deactivation request message information from the management server by requesting hashing of the specific sector deactivation request message information to the management server, and (iii) (iii-1) acquiring a fifth validator signature value by signing the hashed specific sector deactivation request message information with the validator private key and (iii-2) transmitting specific sector deactivation transaction information, including the specific agenda ID, the specific sector index, the third validator nonce value and the fifth validator signature value, to the management server to thereby receive a specific sector deactivation result corresponding to the specific sector deactivation transaction information from the management server.

As another example, the method further includes a step of: (e) in response to the specific sector or the voting result for the specific sector being determined to meet one or more predetermined conditions, the content providing server (i) (i-1) receiving a specific agenda cancellation contract address from the management server by requesting information on the specific agenda cancellation contract address corresponding to the specific agenda to the management server, (i-2) generating specific agenda cancellation request message information, including the specific agenda cancellation contract address and the specific agenda ID, and (i-3) acquiring hashed specific agenda cancellation request message information from the management server by requesting hashing of the specific agenda cancellation request message information to the management server, and (ii) (ii-1) acquiring a sixth validator signature value by signing the hashed specific agenda cancellation request message information with the validator private key and (ii-2) transmitting specific agenda cancellation transaction information, including the specific agenda ID and the sixth validator signature value, to the management server to thereby receive a specific agenda cancellation result corresponding to the specific agenda cancellation transaction information from the management server.

As another example, the method further includes a step of: (f) the content providing server (i) (i-1) determining the specific sector at which the specific agenda is to be executed, (i-2) receiving a specific agenda execution contract address from the management server by requesting information on the specific agenda execution contract address to the management server and (i-3) receiving a fourth validator nonce value and the specific agenda ID by requesting the fourth validator nonce value and the specific agenda ID from the management server, (ii) (ii-1) generating specific agenda execution request message information, including the specific agenda execution contract address, the specific agenda ID, the specific sector index and the fourth validator nonce value, and (ii-2) acquiring hashed specific agenda execution request message information from the management server by requesting hashing of the specific agenda execution request message information to the management server, and (iii) (iii-1) acquiring a seventh validator signature value by signing the hashed specific agenda execution request message information with the validator private key and (iii-2) transmitting specific agenda execution transaction information, including the specific agenda ID, the specific sector index, the fourth validator nonce value and the seventh validator signature value, to the management server to thereby receive a specific agenda execution result corresponding to the specific agenda execution transaction information from the management server.

As another example, at the step of (b), the content providing server transmits the voting request information to the management server and then instructs the management server to (i) acquire the voting message signing request information by decrypting the first user signature value included in the voting request information with a user public key and (ii) transmit the user wallet address included in the voting message signing request information to the content providing server, and wherein the content providing server confirms whether the user wallet address, which is included in the voting message signing request information and transmitted from the management server, and the user wallet address, which is included in the voting request information and transmitted from the user terminal, match with each other, to thereby verify the first user signature value and the user wallet address.

As another example, the method further includes a step of: (g) on condition that (1) the management server has transmitted the user wallet address, a voting token withdrawal contract address and a second user nonce value to the user terminal in response to a voting token withdrawal request received from the user terminal, (2) the user terminal has transmitted voting token withdrawal message signature request information, including the voting token withdrawal contract address, the user wallet address, the specific agenda ID, the specific sector index, a voting token withdrawal quantity and the second user nonce value, to the management server, and then (3) the management server has transmitted a second user signature value, generated by signing the voting token withdrawal message signature request information with the user private key, to the user terminal, (i) receiving, by the content providing server, voting token withdrawal request information, including the voting token withdrawal contract address, the user wallet address, the specific agenda ID, the specific sector index, the voting token withdrawal quantity, the second user nonce value and the second user signature value, transmitted from the user terminal, (ii) (ii-1) performing, by the content providing server, a process of verifying the second user signature value included in the voting token withdrawal request information acquired from the user terminal, (ii-2) acquiring, by the content providing server, a hashed second user signature value by hashing the second user signature value upon completion of the process of verifying the second user signature value, and (ii-3) acquiring, by the content providing server, an eighth validator signature value by signing the hashed second user signature value with the validator private key, and (iii) transmitting, by the content providing server, voting token withdrawal transaction information, including the specific agenda ID, the user wallet address, the specific sector index, the voting token withdrawal quantity, the second user nonce value, the second user signature value and the eighth validator signature value, to the management server, and then receiving, by the content providing server, a voting token withdrawal result corresponding to the voting token withdrawal transaction information from the management server to thereby transmit the voting token withdrawal result to the user terminal.

In accordance with another aspect of the present disclosure, there is provided a content providing server for determining a specific event to be performed on a content based on results of votes obtained through staking of secondary stakable tokens having been acquired by staking primary stakable tokens, including: at least one memory that stores instructions; and at least one processor configured to execute the instructions to perform or support another device to perform: (I) on condition that (i) a management server has transmitted a user wallet address, a voting contract address and a first user nonce value to a user terminal in response to a voting request received from the user terminal, the voting request having been generated through the user terminal by staking the secondary stakable tokens, (ii) the user terminal has transmitted voting message signing request information, including the voting contract address, the user wallet address, a specific agenda ID, a specific sector index corresponding to a specific agenda, a voted quantity of the secondary stakable tokens and the first user nonce value, to the management server, wherein the specific sector index is an index value corresponding to a specific sector, among a 1-st sector to an n-th sector, on which a user of the user terminal intends to vote, and then (iii) the management server has transmitted a first user signature value, generated by signing the voting message signing request information with a user private key, to the user terminal, a process of receiving voting request information, including the voting contract address, the user wallet address, the specific agenda ID, the specific sector index, the voted quantity of the secondary stakable tokens, the first user nonce value and the first user signature value, from the user terminal, (II) a process of (i) verifying the first user signature value included in the voting request information acquired from the user terminal, (ii) acquiring a hashed first user signature value by hashing the first user signature value upon completion of the process of verifying the first user signature value, and (iii) acquiring a first validator signature value by signing the hashed first user signature value with a validator private key, and (III) a process of transmitting voting transaction information, including the specific agenda ID, the user wallet address, the specific sector index, the voted quantity of the secondary stakable tokens, the first user nonce value, the first user signature value and the first validator signature value, to the management server, and then receiving a voting result corresponding to the voting transaction information from the management server, to thereby transmit the voting result to the user terminal.

As another example, the secondary stakable tokens are reward tokens provided to the user by staking the primary stakable tokens, and wherein, before the process of (I), the processor further performs a process of: (I-0) (i) on condition that (1) the management server has transmitted the user wallet address to the user terminal in response to a staking request for the primary stakable tokens from the user terminal, (2) the processor has transmitted first use permission request transaction information to be used for requesting permission to use the primary stakable tokens to the management server and then the management server has transmitted first hashed use permission request transaction information, generated by hashing the first use permission request transaction information, to the processor, (3) the processor has transmitted first staking request transaction information to the management server and then the management server has transmitted first hashed staking request transaction information, generated by hashing the first staking request transaction information, to the processor, and (4) the processor has transmitted the first hashed use permission request transaction information and the first hashed staking request transaction information to the user terminal, the processor instructing the management server to (i-1) receive a signing request on the first hashed use permission request transaction information and the first hashed staking request transaction information, (i-2) generate a first specific user signature value by signing the first hashed use permission request transaction information and the first hashed staking request transaction information with a specific user key, and (i-3) transmit the first specific user signature value to the user terminal, (ii) on condition that (1) the user terminal has transmitted the first hashed use permission request transaction information, the first hashed staking request transaction information and the first specific user signature value to the processor, and (2) the processor has transmitted second use permission request transaction information, including the first hashed use permission request transaction information and the first specific user signature value, to the management server, the processor instructing the management server to invoke a token management contract and execute a token use permission request function whose parameters include a token staking contract address and a staking quantity of the primary stakable tokens, to thereby receive primary stakable token use permission request processing information and transmit the primary stakable token use permission request processing information to the processor, (iii) on condition that the processor has transmitted second staking request transaction information, including the first hashed staking request transaction information and the first specific user signature value, to the management server, the processor instructing the management server to invoke a token staking contract and execute a token staking function whose parameters include the staking quantity of the primary stakable tokens, to thereby receive primary stakable token staking processing information and transmit the primary stakable token staking processing information to the processor, and (iv) (iv-1) the processor determining a quantity of the secondary stakable tokens to be distributed to the user terminal by referring to the primary stakable token staking processing information and (iv-2) the processor granting a voting right for the specific event to be performed on the content to the user terminal by referring to a staking quantity of the secondary stakable tokens.

As another example, the secondary stakable tokens are reward tokens given to the user by staking a-th primary stakable tokens and b-th primary stakable tokens, both of which are among the first primary tokens, and wherein, before the process of (I), the processor further performs a process of: (I-1) (i) on condition that (1) the management server has transmitted the user wallet address to the user terminal in response to a staking request for at least one of the primary stakable tokens among the a-th primary stakable tokens and the b-th primary stakable tokens from the user terminal, (2) the processor has transmitted first use permission request transaction information to be used for requesting permission to use the primary stakable tokens to the management server and then the management server has transmitted first hashed use permission request transaction information, generated by hashing the first use permission request transaction information, to the processor, (3) the processor has transmitted first staking request transaction information to the management server and then the management server has transmitted first hashed staking request transaction information, generated by hashing the first staking request transaction information, to the processor, and (4) the processor has transmitted the first hashed use permission request transaction information and the first hashed staking request transaction information to the user terminal, the processor instructing the management server to (i-1) receive a signing request on the first hashed use permission request transaction information and the first hashed staking request transaction information from the user terminal, (i-2) generate a first specific user signature value by signing the first hashed use permission request transaction information and the first hashed staking request transaction information with a specific user key, and (i-3) transmit the first specific user signature value to the user terminal, (ii) on condition that (1) the user terminal has transmitted the first hashed use permission request transaction information, the first hashed staking request transaction information and the first specific user signature value to the processor, and (2) the processor has transmitted second use permission request transaction information, including the first hashed use permission request transaction information and the first specific user signature value, to the management server, the processor instructing the management server to invoke a token management contract and execute a token use permission request function whose parameters include a token staking contract address and a staking quantity of the primary stakable token, to thereby receive primary stakable token use permission request processing information and transmit the primary stakable token use permission request processing information to the processor, (iii) on condition that the processor has transmitted second staking request transaction information, including the first hashed staking request transaction information and the first specific user signature value, to the management server, the processor instructing the management server to invoke a token staking contract and execute a token staking function whose parameters include the staking quantity of the primary stakable token, to thereby receive primary stakable token staking processing information and transmit the primary stakable token staking processing information to the processor, and (iv) (iv-1) the processor determining a quantity of the secondary stakable tokens to be distributed to the user terminal by referring to the primary stakable token staking processing information and (iv-2) the processor granting a voting right for the specific event to be performed on the content to the user terminal by referring to a staking quantity of the secondary stakable tokens.

As another example, at the process of (I), the processor further performs a process of: (I-2) on condition that the management server has transmitted the user wallet address, linked to the user terminal, to the user terminal in response to receiving the voting request from the user terminal, (i) the processor receiving request information for the voting contract address from the user terminal, (ii) the processor transmitting the request information for the voting contract address to the management server and the processor receiving the voting contract address corresponding to the request information from the management server to transmit the voting contract address to the user terminal, and (iii) on condition that the first user nonce value corresponding to the voting contract has been transmitted to the user terminal in response to a request for the first user nonce value from the user terminal, the processor instructing the user terminal to generate the voting message signing request information, including the voting contract address, the user wallet address, the specific agenda ID, the specific sector index corresponding to the specific agenda, the voted quantity of the secondary stakable tokens and the first user nonce value.

As another example, before the process of (I-2), the processor further performs a process of: (I-01) the processor (i) (i-1) receiving a specific agenda generation contract address from the management server by requesting information on the specific agenda generation contract address, corresponding to the specific agenda, to the management server and (i-2) receiving a previous agenda ID, which is most recently generated by requesting the previous agenda ID from the management server, (ii) (ii-1) generating specific agenda generation request message information, including the specific agenda generation contract address, the previous agenda ID, specific agenda generation purpose information corresponding to the specific agenda, a minimum voting quantity of the secondary stakable tokens, cool time information corresponding to the specific agenda and cancel lock information corresponding to the specific agenda, and (ii-2) acquiring hashed specific agenda generation request message information from the management server by requesting hashing of the specific agenda generation request message information to the management server, and (iii) (iii-1) acquiring a second validator signature value by signing the hashed specific agenda generation request message information with the validator private key and (iii-2) transmitting specific agenda generation transaction information, including the specific agenda generation purpose information, the minimum voting quantity of the secondary stakable tokens, the cool time information, the cancel lock information and the second validator signature value, to the management server to thereby receive a specific agenda generation result corresponding to the specific agenda generation transaction information from the management server.

As another example, the processor further performs a process of: (I-02) the processor (i) (i-1) receiving a specific sector generation contract address from the management server by requesting information on the specific sector generation contract address, corresponding to the specific sector index, to the management server and (i-2) receiving a first validator nonce value and the specific agenda ID by requesting the first validator nonce value and the specific agenda ID from the management server, (ii) (ii-1) generating specific sector generation request message information, including the specific sector generation contract address, the specific agenda ID, the first validator nonce value, specific sector generation purpose information and a specific sector account address, and (ii-2) acquiring hashed specific sector generation request message information from the management server by requesting hashing of the specific sector generation request message information to the management server, and (iii) (iii-1) acquiring a third validator signature value by signing the hashed specific sector generation request message information with the validator private key and (iii-2) transmitting specific sector generation transaction information, including the specific agenda ID, the first validator nonce value, the specific sector generation purpose information, the specific sector account address and the third validator signature value, to the management server to thereby receive a specific sector generation result corresponding to the specific sector generation transaction information from the management server.

As another example, at the process of (I-02), in order to change the specific sector to which the specific agenda is applied to another sector, the processor further performs a process of: the processor (i) (i-1) receiving a sector change contract address from the management server by requesting information on the sector change contract address to the management server and (i-2) receiving a second validator nonce value and the specific agenda ID by requesting the second validator nonce value and the specific agenda ID from the management server, (ii) (ii-1) generating sector change request message information, including the sector change contract address, the specific agenda ID, the second validator nonce value, another sector index corresponding to the another sector, sector change purpose information and another sector account address corresponding to the another sector, and (ii-2) acquiring hashed sector change request message information from the management server by requesting hashing of the sector change request message information to the management server and (iii) (iii-1) acquiring a fourth validator signature value by signing the hashed sector change request message information with the validator private key and (iii-2) transmitting sector change transaction information, including the specific agenda ID, the second validator nonce value, the sector change purpose information, the another sector index, the another sector account address and the fourth validator signature value, to the management server to thereby receive a sector change result corresponding to the sector change transaction information from the management server.

As another example, the processor further performs a process of: (IV) in order to deactivate the specific sector, the processor (i) (i-1) requesting information on a specific sector deactivation contract address corresponding to the specific sector index to the management server to thereby receive the specific sector deactivation contract address and (i-2) receiving a third validator nonce value and the specific agenda ID by requesting the third validator nonce value and the specific agenda ID from the management server, (ii) (ii-1) generating specific sector deactivation request message information, including the specific sector deactivation contract address, the specific agenda ID, the specific sector index and the third validator nonce value, and (ii-2) acquiring hashed specific sector deactivation request message information from the management server by requesting hashing of the specific sector deactivation request message information to the management server, and (iii) (iii-1) acquiring a fifth validator signature value by signing the hashed specific sector deactivation request message information with the validator private key and (iii-2) transmitting specific sector deactivation transaction information, including the specific agenda ID, the specific sector index, the third validator nonce value and the fifth validator signature value, to the management server to thereby receive a specific sector deactivation result corresponding to the specific sector deactivation transaction information from the management server.

As another example, the processor further performs a process of: (V) in response to the specific sector or the voting result for the specific sector being determined to meet one or more predetermined conditions, the processor (i) (i-1) receiving a specific agenda cancellation contract address from the management server by requesting information on the specific agenda cancellation contract address corresponding to the specific agenda to the management server, (i-2) generating specific agenda cancellation request message information, including the specific agenda cancellation contract address and the specific agenda ID, and (i-3) acquiring hashed specific agenda cancellation request message information from the management server by requesting hashing of the specific agenda cancellation request message information to the management server, and (ii) (ii-1) acquiring a sixth validator signature value by signing the hashed specific agenda cancellation request message information with the validator private key and (ii-2) transmitting specific agenda cancellation transaction information, including the specific agenda ID and the sixth validator signature value, to the management server to thereby receive a specific agenda cancellation result corresponding to the specific agenda cancellation transaction information from the management server.

As another example, the processor further performs a process of: (VI) the processor (i) (i-1) determining the specific sector at which the specific agenda is to be executed, (i-2) receiving a specific agenda execution contract address from the management server by requesting information on the specific agenda execution contract address to the management server and (i-3) receiving a fourth validator nonce value and the specific agenda ID by requesting the fourth validator nonce value and the specific agenda ID from the management server, (ii) (ii-1) generating specific agenda execution request message information, including the specific agenda execution contract address, the specific agenda ID, the specific sector index and the fourth validator nonce value, and (ii-2) acquiring hashed specific agenda execution request message information from the management server by requesting hashing of the specific agenda execution request message information to the management server, and (iii) (iii-1) acquiring a seventh validator signature value by signing the hashed specific agenda execution request message information with the validator private key and (iii-2) transmitting specific agenda execution transaction information, including the specific agenda ID, the specific sector index, the fourth validator nonce value and the seventh validator signature value, to the management server to thereby receive a specific agenda execution result corresponding to the specific agenda execution transaction information from the management server.

As another example, at the process of (II), the processor transmits the voting request information to the management server and then instructs the management server to (i) acquire the voting message signing request information by decrypting the first user signature value included in the voting request information with a user public key and (ii) transmit the user wallet address included in the voting message signing request information to the processor, and wherein the processor confirms whether the user wallet address, which is included in the voting message signing request information and transmitted from the management server, and the user wallet address, which is included in the voting request information and transmitted from the user terminal, match with each other, to thereby verify the first user signature value and the user wallet address.

As another example, the processor further performs a process of: (VII) on condition that (1) the management server has transmitted the user wallet address, a voting token withdrawal contract address and a second user nonce value to the user terminal in response to a voting token withdrawal request received from the user terminal, (2) the user terminal has transmitted voting token withdrawal message signature request information, including the voting token withdrawal contract address, the user wallet address, the specific agenda ID, the specific sector index, a voting token withdrawal quantity and the second user nonce value, to the management server, and then (3) the management server has transmitted a second user signature value, generated by signing the voting token withdrawal message signature request information with the user private key, to the user terminal, (i) the processor receiving voting token withdrawal request information, including the voting token withdrawal contract address, the user wallet address, the specific agenda ID, the specific sector index, the voting token withdrawal quantity, the second user nonce value and the second user signature value, transmitted from the user terminal, (ii) (ii-1) the processor performing a process of verifying the second user signature value included in the voting token withdrawal request information acquired from the user terminal, (ii-2) the processor acquiring a hashed second user signature value by hashing the second user signature value upon completion of the process of verifying the second user signature value, and (ii-3) the processor acquiring an eighth validator signature value by signing the hashed second user signature value with the validator private key, and (iii) the processor transmitting voting token withdrawal transaction information, including the specific agenda ID, the user wallet address, the specific sector index, the voting token withdrawal quantity, the second user nonce value, the second user signature value and the eighth validator signature value, to the management server, and then the processor receiving a voting token withdrawal result corresponding to the voting token withdrawal transaction information from the management server to thereby transmit the voting token withdrawal result to the user terminal.

In addition, recordable media that are readable by a computer for storing a computer program to execute the method of the present disclosure is further provided.

### BRIEF DESCRIPTION OF THE DRAWINGS

The above and other objects and features of the present disclosure will become apparent from the following description of preferred embodiments given in conjunction with the accompanying drawings. The accompanying drawings used to explain example embodiments of the present disclosure are only part of example embodiments of the present disclosure and other drawings can be obtained based on the drawings by those skilled in the art of the present disclosure without inventive work.

FIG. 1 is a drawing schematically illustrating a configuration of a system that acquires secondary stakable tokens by staking primary stakable tokens and determines a specific event to be executed on a content by referring to a voting result obtained by staking the secondary stakable tokens in accordance with one example embodiment of the present disclosure.

FIG. 2 is a drawing schematically illustrating a content providing server that determines the specific event to be executed on the content by referring to the voting result obtained by staking the secondary stakable tokens in accordance with one example embodiment of the present disclosure.

FIG. 3 is a drawing schematically illustrating a sequence diagram in which a user stakes the primary stakable tokens to acquire the second stakable tokens in accordance with one example embodiment of the present disclosure.

FIG. 4 is a drawing schematically illustrating a sequence diagram of generating and transmitting voting transaction information to a blockchain intermediary server in response to a voting request from a user terminal and thus transmitting the voting result to the user terminal in accordance with one example embodiment of the present disclosure.

FIG. 5 is a drawing schematically illustrating a sequence diagram of generating and transmitting specific agenda generation transaction information to the blockchain intermediary server in response to a generation request for a specific agenda and thus transmitting a specific agenda generation result to the content providing server in accordance with one example embodiment of the present disclosure.

FIG. 6 is a drawing schematically illustrating a sequence diagram of generating and transmitting specific sector generation transaction information to the blockchain intermediary server in response to a generation request for a specific sector and thus transmitting a specific sector generation result to the content providing server in accordance with one example embodiment of the present disclosure.

FIG. 7 is a drawing schematically illustrating a sequence diagram of generating and transmitting sector change transaction information to the blockchain intermediary server in response to a sector change request and thus transmitting a sector change result to the content providing server in accordance with one example embodiment of the present disclosure.

FIG. 8 is a drawing schematically illustrating a sequence diagram of generating and transmitting specific sector deactivation transaction information to the blockchain intermediary server in response to a specific sector deactivation request and thus transmitting a specific sector deactivation result to the content providing server in accordance with one example embodiment of the present disclosure.

FIG. 9 is a drawing schematically illustrating a sequence diagram of generating and transmitting specific agenda cancellation transaction information to the blockchain intermediary server in response to a specific agenda cancellation request and thus transmitting a specific agenda cancellation result to the content providing server in accordance with one example embodiment of the present disclosure.

FIG. 10 is a drawing schematically illustrating a sequence diagram of generating and transmitting specific agenda execution transaction information to the blockchain intermediary server in response to a specific agenda execution request and thus transmitting a specific agenda execution result to the content providing server in accordance with one example embodiment of the present disclosure.

FIG. 11 is a drawing schematically illustrating a sequence diagram of generating and transmitting voting token withdrawal transaction information to the blockchain intermediary server in response to a voting token withdrawal request made by the user terminal and thus transmitting a voting token withdrawal result to the user terminal in accordance with one example embodiment of the present disclosure.

### DETAILED DESCRIPTION OF THE PREFERRED EMBODIMENTS

The following detailed description of the present disclosure refers to the accompanying drawings, which show by way of illustration a specific embodiment in which the present disclosure may be practiced, in order to clarify the objects, technical solutions and advantages of the present disclosure. These embodiments are described in sufficient detail to enable those skilled in the art to practice the present disclosure.

Besides, in the detailed description and claims of the present disclosure, a term “include” and its variations are not intended to exclude other technical features, additions, components or steps. Other objects, benefits and features of the present disclosure will be revealed to one skilled in the art, partially from the specification and partially from the implementation of the present disclosure. The following examples and drawings will be provided as examples but they are not intended to limit the present disclosure.

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the present disclosure, although different, are not necessarily mutually exclusive. For example, a particular feature, structure, or characteristic described herein in connection with one embodiment may be implemented within other embodiments without departing from the spirit and scope of the present disclosure. In addition, it is to be understood that the position or arrangement of individual elements within each disclosed embodiment may be modified without departing from the spirit and scope of the present disclosure. The following detailed description is, therefore, not to be taken in a limiting sense, and the scope of the present disclosure is defined only by the appended claims, appropriately interpreted, along with the full range of equivalents to which the claims are entitled. In the drawings, like numerals refer to the same or similar functionality throughout the several views.

The headings and abstract of the present disclosure provided herein are for convenience only and do not limit or interpret the scope or meaning of the embodiments.

As used in this specification and the appended claims, the singular forms “a,” “an,” and “the” may include plural referents unless the content and context clearly dictates otherwise.

To allow those skilled in the art to carry out the present disclosure easily, the example embodiments of the present disclosure will be explained by referring to attached diagrams in detail as shown below.

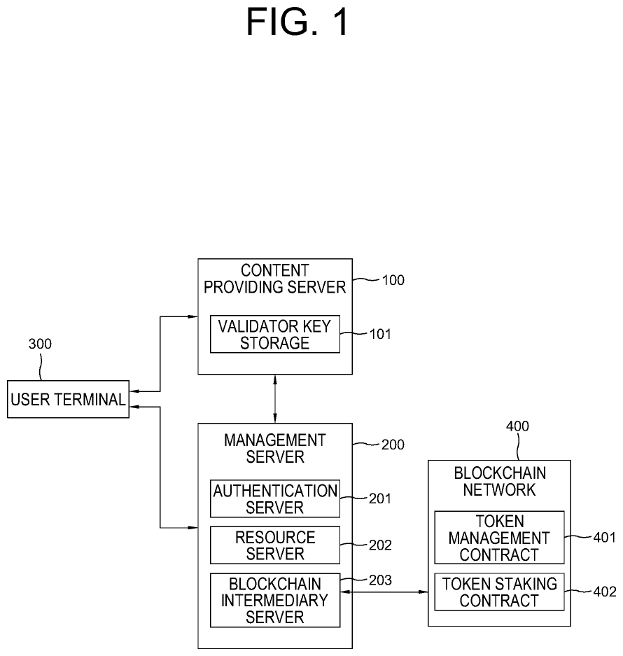

FIG. 1 is a drawing schematically illustrating a configuration of a system that acquires secondary stakable tokens by staking primary stakable tokens and determines a specific event to be executed on a content by referring to a voting result obtained by staking the secondary stakable tokens in accordance with one example embodiment of the present disclosure.

By referring to FIG. 1, a content providing server 100, as a server that provides content services to users, may receive a voting request for the secondary stakable tokens or a voting token withdrawal request from a user terminal 300. Then, the content providing server 100 may interact with a management server 200 and perform processes corresponding to the voting request and the voting token withdrawal request, in response to the requests thereof made by the user terminal 300. For reference, the content in the present disclosure may be, but is not limited to, a game content.

In addition, the content providing server 100 may request a generation of a specific agenda to the management server 200. Herein, the specific agenda may refer to the specific event that takes place on the content, for example, an event in which users of each server enjoying the content strive to win and monopolize expensive goods through battles with other users of other servers for the benefit of their respective servers, but examples of the specific agenda are not limited thereto.

Next, the content providing server 100 may request a generation of a specific sector to the management server 200. Herein, the specific sector may be a specific server to which the specific agenda will be applied among multiple servers for providing the content, and may be any one of a 1-st sector to an n-th sector. When there are multiple sectors being operated, the users may exercise their influence by staking their secondary stakable tokens on their sectors, i.e., servers, and the amount of staking voted on each sector may be compared to thereby apply the specific agenda to the specific sector having a higher amount or a highest amount of staking. Herein, the specific sector may be one sector or multiple sectors. Herein, an act of staking the secondary stakable tokens in the specific sector may be construed to mean the same as voting for the specific sector, and in this case, staking the primary stakable tokens to acquire the secondary stakable tokens and staking the secondary stakable tokens to determine the specific sector to which the specific agenda will be applied should be interpreted as distinct.

Herein, the secondary stakable tokens may be a type of reward tokens given to users who stake the primary stakable tokens, and may be so-called governance tokens. Herein, the primary stakable tokens may be obtained by the user who exchanges them with underlying assets in the content (the underlying assets refer to the most basic type of goods that are acquired by performing missions, detailed content, etc. while playing the content) at a certain exchange rate, and the secondary stakable tokens may be obtained by staking the primary stakable tokens.

Herein, by staking the primary stakable tokens, the users who enjoy the content may play a role in contributing to burning of the underlying assets which the users have exchanged at the certain exchange rate (which has an effect of keeping a total amount of the underlying assets in the content at a certain level by burning the underlying assets being circulated in the content). The secondary stakable tokens may then be acquired as a reward for such contribution. The users may also be able to stake the secondary stakable tokens to determine the specific event to be taken place on the content, thereby demonstrating their influence within the content.

At this time, as a result of the voting, it may be determined which of the multiple sectors (servers) in the content the specific agenda will be applied to, and an efficiency of a process of operating the content may be improved by ensuring that the specific agenda is only applied to the specific sector.

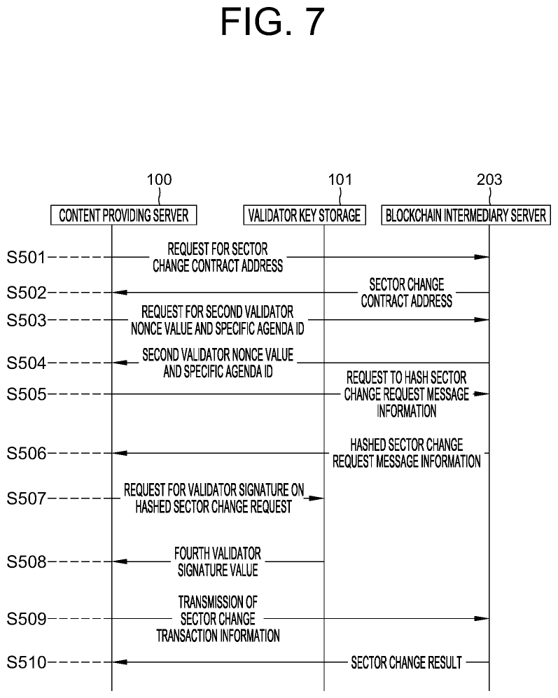

Also, the content providing server 100 may transmit requests for changing sectors, deactivating the specific sector, cancelling the specific agenda and executing the specific agenda to the management server 200, whose related explanations will be provided in detail with reference to the corresponding sequence diagrams in FIGS. 7 to 10.

Meanwhile, the content providing server 100 may include a validator key storage 101. Herein, a validator key may be used to generate a validator signature value by signing a hashed user signature value or various hashed request information, and although the present disclosure describes the validator key storage 101 as being included in the content providing server 100, the present disclosure is not limited thereto and it is also possible that the validator key storage 101 operates in conjunction with the content providing server 100.

Next, the management server 200 may be a server that interacts with the content providing server 100 and the user terminal 300. Herein, the management server 200 may include an authentication server 201, a resource server 202, and a blockchain intermediary server 203. In this case, each of the authentication server 201, resource server 202, and blockchain intermediary server 203 included in the management server 200 may be implemented as a physical server or a software server. As another example, at least some of the authentication server 201, the resource server 202, and the blockchain intermediary server 203 may not be included within the management server 200. On the other hand, the claims of this specification are described in terms of the management server 200 and while this may be construed as the management server 200 itself performing as a unified entity (although the claims do not mention the authentication server 201, the resource server 202, and the blockchain intermediary server 203 per se), it is, of course, possible that each of the authentication server 201, the resource server 202, and the blockchain intermediary server 203 may be construed as performing the same act as an individual entity. This is because various implementations of the servers may be readily derived by those skilled in the art.

First, the authentication server 201 may be a server that authenticates a user and issues an access token to the user terminal 300. Herein, the access token may refer to an authentication token provided to the user once the user completes user authentication by logging into an electronic wallet app in order to obtain an electronic wallet address. The resource server 202 may be a third-party platform (e.g., Google, Facebook, Twitter, etc.) server that stores resources for the user. Herein, the resources may be, but are not limited to, information about the users on another platform, such as the user's name, address, age, etc. Further, the blockchain intermediary server 203 may be a server that receives transaction information from the content providing server 100 and transmits corresponding transactions to a blockchain network 400.

In addition, the user terminal 300 may be a terminal of each of the users utilizing the content, and may be a terminal that performs the voting request of the secondary stakable tokens and a withdrawal request of voted tokens, or a terminal that performs a staking request, an unstaking request, and a redeeming request of the primary stakable tokens, and in some cases, may be a terminal that performs both. Further, the blockchain network 400 may be a network that interacts with the blockchain intermediary server 203 and stores transactions, and a token management contract 401 and a token staking contract 402 may play a role in executing a token use permission request function and a token staking function respectively to thereby process corresponding transaction information.

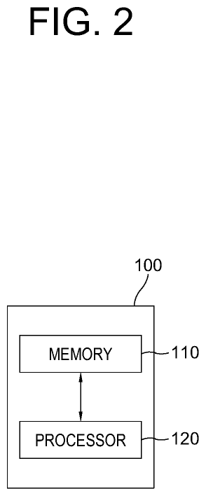

FIG. 2 is a drawing schematically illustrating the content providing server that issues the secondary stakable tokens as reward tokens to the users through staking of the primary stakable tokens and determines the specific event to be executed on the content by referring to the voting result obtained by staking the secondary stakable tokens in accordance with one example embodiment of the present disclosure.

By referring to FIG. 2, the content providing device 100 may include a memory 110 for storing instructions to issue the secondary stakable tokens as the reward tokens to the users through staking of the primary stakable tokens and to determine the specific event (i.e., a series of processes that determine which sector the specific agenda will be applied to) to be executed on the content by referring to the voting result obtained by staking the secondary stakable tokens, and a processor 120 for issuing the secondary stakable tokens as the reward tokens to the users through staking of the primary stakable tokens, and determining the specific event to be executed on the content by referring to the voting result obtained by staking the secondary stakable tokens according to the instructions in the memory 110. Herein, the memory 110 of the content providing server 100 may store instructions to be performed by the processor 120 and specifically, the instructions may be code generated for the purpose of instructing the content providing server 100 to function in a particular manner and may be stored in a computer-usable or computer-readable memory capable of being directed to a computer or other programmable data processing equipment. The instructions may perform processes to execute functions described in the specification of the present disclosure.

The processor 120 of the content providing server 100 may include hardware configuration of MPU (Micro Processing Unit) or CPU (Central Processing Unit), cache memory, data bus, etc.

Additionally, the computing device may further include OS and software configuration of applications that achieve specific purposes.

Additionally, the content providing server 100 may be linked to a database (not shown). Herein, the database (not shown) may include at least one type of storage medium among a flash memory type, hard disk type, multimedia card micro type, card-type memory (for example, SD or XD memory), Random Access Memory (RAM), Static Random Access Memory (SRAM), ReadOnly Memory (ROM), Electrically Erasable Programmable ReadOnly Memory (EEPROM), Programmable ReadOnly Memory (PROM), magnetic memory, magnetic disk, and optical disk, but is not limited to this and may include any medium capable of storing data.

In addition, although not shown in FIG. 2, the management server 200 and the user terminal 300 may also be configured to include respective memories and processes.

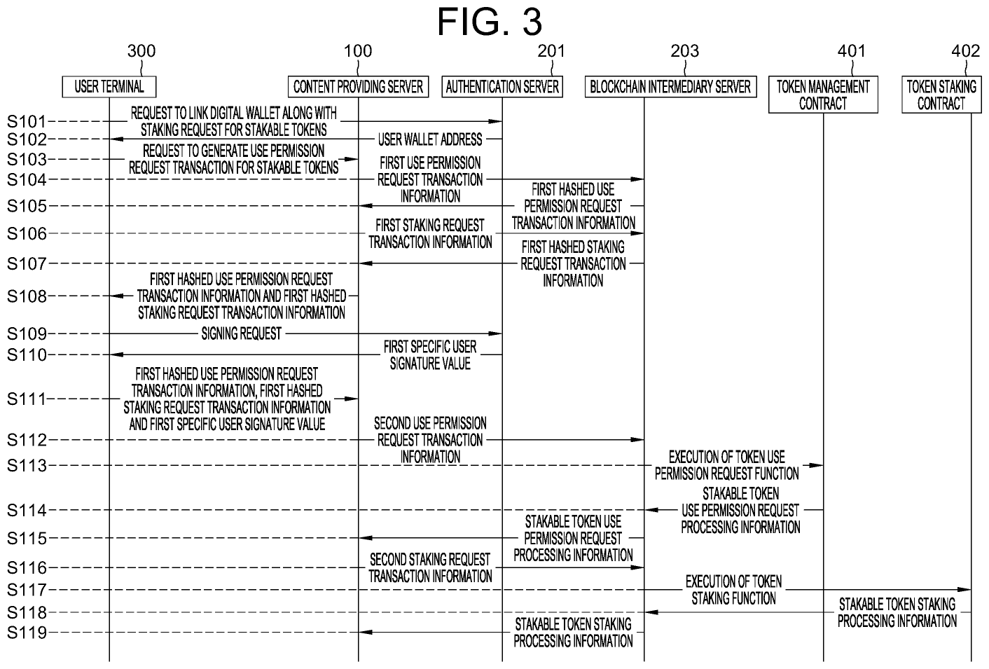

FIG. 3 is a drawing schematically illustrating a sequence diagram in which the user stakes the primary stakable tokens to acquire the second stakable tokens in accordance with one example embodiment of the present disclosure.

In this case, the secondary stakable tokens may be the reward tokens issued to the user through staking of at least one type of the primary stakable tokens. Herein, the primary stakable token may be of one type, but hereinafter, it is assumed that there are multiple types, and thus staking of a-th primary stakable tokens and b-th primary stakable tokens is explained by way of example.

By referring to FIG. 3, the user terminal 300 may request staking of at least one of the primary stakable tokens among the a-th primary stakable tokens and the b-th primary stakable tokens, along with a request for linking of the electronic wallet, to the authentication server 201 included in the management server 200 at a step of S101. Of course, the step of S101 may also assume a case where there is only one type of the primary stakable tokens, in which case the step S101 may also be interpreted as requesting staking of that one type of primary stakable tokens along with the request to connect the electronic wallet. Following, the authentication server 201 included in the management server 200 may verify the user and then transmit a user wallet address to the user terminal 300 at a step of S102.

Also, on condition that the content providing server 100 has received a request for generating a use permission request transaction for the primary stakable tokens from the user terminal 300 at a step of S103, the content providing server 100 may transmit first use permission request transaction information to be used for requesting permission to use the primary stakable tokens to the blockchain intermediary server 203 at a step of S104. Then, the blockchain intermediary server 203 may transmit first hashed use permission request transaction information, generated by hashing the first use permission request transaction information, to the content providing server 100 at a step of S105.

Next, the content providing server 100 may transmit first staking request transaction information to the blockchain intermediary server 203 at a step of S106. Then, the blockchain intermediary server 203 may transmit first hashed staking request transaction information, generated by hashing the first staking request transaction information, to the content providing server 100 at a step of S107.

In addition, the content providing server 100 may transmit the first hashed use permission request transaction information and the first hashed staking request transaction information to the user terminal 300 at a step of S108. Then, the content providing server 100 may instruct the authentication server 201 included in the management server 200 to receive a signing request on the first hashed use permission request transaction information and the first hashed staking request transaction information from the user terminal 300 at a step of S109, such that the authentication server 201 may generate a first specific user signature value by signing the first hashed use permission request transaction information and the first hashed staking request transaction information with a specific user key and transmit the first specific user signature value to the user terminal 300 at a step of S110.

Next, the first hashed use permission request transaction information, the first hashed staking request transaction information and the first specific user signature value may be transmitted by the user terminal 300 to the content providing server 100 at a step of S111. Then, second use permission request transaction information, including the first hashed use permission request transaction information and the first specific user signature value, may be transmitted by the content providing server 100 to the blockchain intermediary server 203 at a step of S112.

In addition, the content providing server 100 may perform a process of instructing the blockchain intermediary server 203 to invoke a token management contract 401 and execute a token use permission request function whose parameters include a token staking contract address and a staking quantity of the primary stakable tokens at a step of S113, to thereby receive primary stakable token use permission request processing information at a step of S114 and transmit the primary stakable token use permission request processing information to the content providing server 100 at a step of S115.

Following, the content providing server 100 may transmit second staking request transaction information, including the first hashed staking request transaction information and the first specific user signature value, to the blockchain intermediary server 203 at a step of S116. Then, the content providing server 100 may instruct the blockchain intermediary serve 203 to invoke a token staking contract 402 and execute a token staking function whose parameters include the staking quantity of the primary stakable tokens at a step of S117, to thereby receive primary stakable token staking processing information at a step of S118 and transmit the primary stakable token staking processing information to the content providing server 100 at a step of S119. Afterwards, the content providing server 100 may transmit the primary stakable token staking processing information to the user terminal 300. Herein, the content providing server 100 may determine a quantity of the secondary stakable tokens to be distributed to the user terminal 300 by referring to the primary stakable token staking processing information and grant a voting right for the specific event to be performed on the content to the user terminal 300 by referring to a staking quantity of the secondary stakable tokens.

As explained in FIG. 3, when the user stakes the primary stakable tokens and requests a reward for the primary stakable tokens after a period of time, the content providing server 100 may provide the user with an amount of the secondary stakable tokens corresponding to the period of time as the reward tokens, and based on the amount of secondary stakable tokens provided, voting may be performed for the corresponding sector as mentioned above.

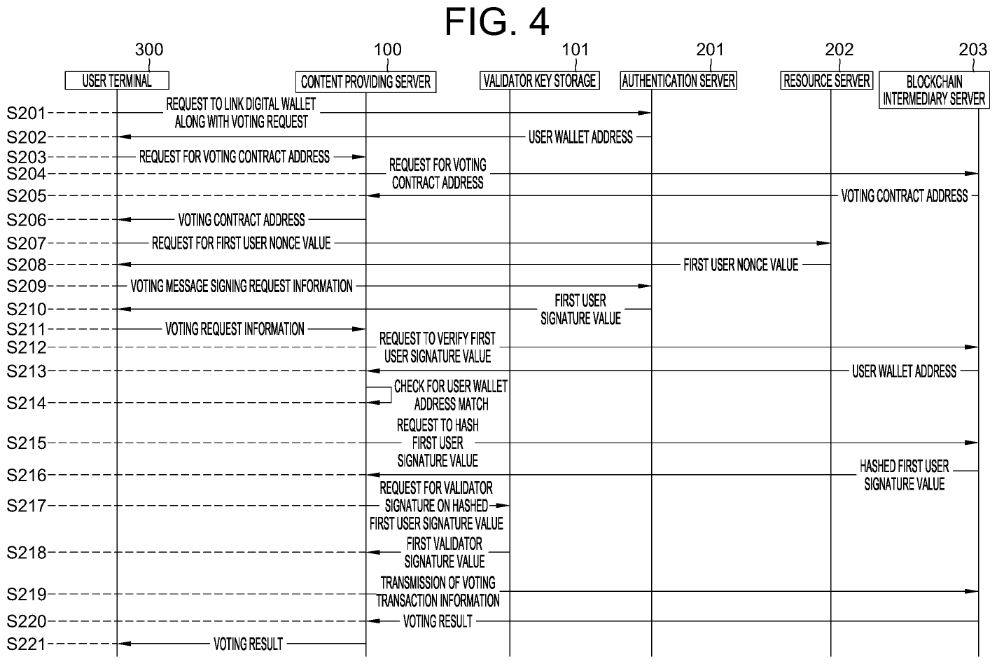

FIG. 4 is a drawing schematically illustrating a sequence diagram of generating and transmitting voting transaction information to the blockchain intermediary server in response to the voting request made by the user terminal and thus transmitting the voting result to the user terminal in accordance with one example embodiment of the present disclosure.

By referring to FIG. 4, the user terminal may make the voting request to the authentication server 210 included in the management server 200, along with a request for linking of the electronic wallet, at a step of S201. The, the authentication server 201 may verify the user and transmit the user wallet address to the user terminal 300 at a step of S202. Herein, the authentication server 201 may issue the access token, which is authentication information for verifying the user, to the user terminal 300 along with the user wallet address.

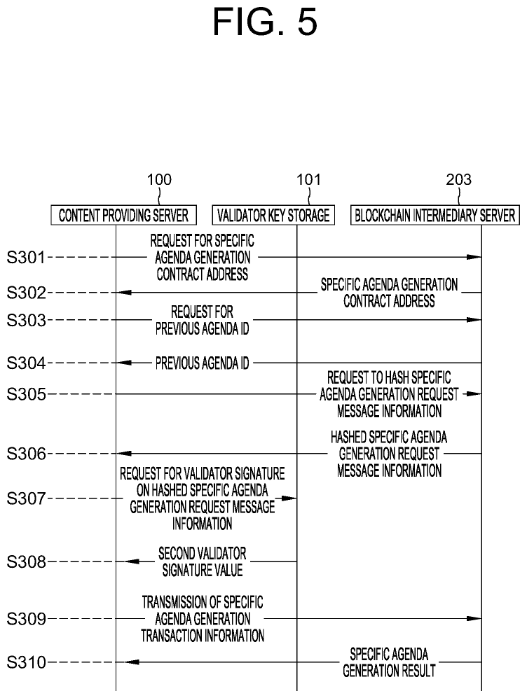

Also, the user terminal 300 may request a voting contract address to the content providing server 100 at a step of S203. Then, the content providing server 100 may request the voting contract address to the blockchain intermediary server 203 at a step of S204, and in response, the blockchain intermediary server 203 may receive the voting contract address from the blockchain network 400 and then transmit the voting contract address to the content providing server 100 at a step of S205. Afterwards, the content providing server 100 may transmit the voting contract address received from the blockchain intermediary server 203 to the user terminal 300 at a step of S206. Herein, the smart contract referred to as the voting contract in FIG. 4 may be implemented as a different smart contract from a specific agenda generation contract, a specific sector generation contract, a sector change contract, a specific sector deactivation contract, a specific agenda cancellation contract, a specific agenda execution contract, and a voting token withdrawal contract to be described in each of FIGS. 5 to 11, but in some cases, at least some of the contracts may be implemented as the same smart contract.

Next, the user terminal 300 may transmit a request for a first user nonce value to the resource server 202 included in the management server 200 at a step of S207. Herein, when the user terminal 300 requests the first user nonce value from the resource server 202, the user terminal 300 may also transmit the access token obtained from the authentication server 201 so that the resource server 202 can verify the access token and obtain the first user nonce value at a step of S208 as a result of the verification, but the present disclosure is not limited thereto.

In addition, the user terminal 300 may generate and transmit voting message signing request information, including the voting contract address, the user wallet address, a specific agenda ID, a specific sector index corresponding to a specific agenda, a voted quantity of the secondary stakable tokens and the first user nonce value, to the authentication server 201 of the management server 200 at a step of S209. Herein, the specific sector index is an index value corresponding to the specific sector, among the 1-st sector to the n-th sector, on which the user intends to vote. Then, the authentication server 201 may transmit a first user signature value, generated by signing the voting message signing request information with a user private key, to the user terminal 300 at a step of S210.

Next, the user terminal 300 may transmit voting request information, including the voting contract address, the user wallet address, the specific agenda ID, the specific sector index, the voted quantity of the secondary stakable tokens, the first user nonce value and the first user signature value, to the content providing server 100 at a step of S211. Then, the content providing server 100 may transmit the voting request information to the blockchain intermediary server 203, and thus request the blockchain intermediary server 203 to verify the first user signature valuer included in the voting request information at a step of S212.

At this time, the content providing server 100 may transmit the voting request information to the blockchain intermediary server 203, and thus request the blockchain intermediary server 203 to decrypt the first user signature value included in the voting request information by using a user public key to obtain the voting message signing request information, and to transmit the user wallet address included in the voting message signing request information to the content providing server 100 at a step of S213. Then, the content providing server 100 may verify the first user signature value and the user wallet address by verifying whether the user wallet address included in the voting message signing request information obtained from the blockchain intermediary server 203 and the user wallet address included in the voting request information received from the user terminal 300 match with each other at a step of S214, but the present disclosure is not limited thereto.

In addition, the content providing server 100 may request the blockchain intermediary server 203 to hash the first user signature value at a step of S215. Then, the blockchain intermediary server 203 may transmit hashed first user signature value, generated by hashing the first user signature value, to the content providing server 100 at a step of S216. Further, the content providing server 100 may transmit a request for a verifier signature for the hashed first user signature value to the validator key storage 101 included in the content providing server 100 at a step of S217. The validator key storage 101 may then transmit a first validator signature value, generated by signing the hashed first user signature value with a validator private key, to the content providing server 100 at a step of S218. Herein, the first verifier signature value is a validator's signature for the user's voting process using the secondary stakable tokens.

Next, the content providing server 100 may transmit voting transaction information, including the specific agenda ID, the user wallet address, the specific sector index, the voted quantity of the secondary stakable tokens, the first user nonce value, the first user signature value and the first validator signature value, to the blockchain intermediary server 203 at a step of S219. Then, the blockchain intermediary server 203 may generate a voting transaction via its interaction with the blockchain network 400. Afterwards, the content providing server 100 may receive the voting result corresponding to the voting transaction information from the blockchain intermediary server 203 and then transmit the voting result to the user terminal 300 at a step of S221.

FIG. 5 is a drawing schematically illustrating a sequence diagram of generating and transmitting specific agenda generation transaction information to the blockchain intermediary server in response to a generation request for the specific agenda and thus transmitting a specific agenda generation result to the content providing server in accordance with one example embodiment of the present disclosure.

By referring to FIG. 5, the content providing server 100 may transmit a request for a specific agenda generation contract address to the blockchain intermediary server 203 at a step of S301. Then, the blockchain intermediary server 203 may transmit the specific agenda generation contract address to the content providing server 100 at a step of S302.

In addition, the content providing server 100 may transmit a request for a previous agenda ID, which is most recently generated, to the blockchain intermediary server 203 at a step of S303, and then receive the previous agenda ID from the blockchain intermediary server 203 at a step of S304. Herein, if there is no previously generated agenda ID, a NULL value may be generated and transmitted to the content providing server 100.

Next, the content providing server 100 may generate specific agenda generation request message information, including the specific agenda generation contract address, the previous agenda ID, specific agenda generation purpose information corresponding to the specific agenda, a minimum voting quantity of the secondary stakable tokens, cool time information corresponding to the specific agenda and cancel lock information corresponding to the specific agenda, and request the blockchain intermediary server 203 to hash the specific agenda generation request message information at a step of S305. Herein, the cool time information may refer to a time limit for the user to cancel a vote in a staking pool. That is, the cool time information may refer to a certain period of time the user must wait before canceling the vote. During this period of time, the vote cannot be canceled, meaning that the vote can be canceled only after the certain period of time. In addition, the cancel lock information may refer to a time limit for the user to cancel the next vote after having canceled a previous vote. In the staking pool, once a participant has canceled a vote, the next vote cannot be canceled for a specific period of time, which may prevent the participant from repeatedly canceling votes.

Then, the blockchain intermediary server 203 may transmit hashed specific agenda generation request message information, generated by hashing the specific agenda generation request message information, to the content providing server 100 at a step of S306.

In addition, the content providing server 100 may transmit a request for a validator signature on the hashed specific agenda generation request message information to the validator key storage 101 included in the content providing server 100 at a step of S307. Then, the validator key storage 101 may generate a second validator signature value by signing the hashed specific agenda generation request message information with the validator private key and transmit the second validator signature value to the content providing server 100 at a step of S308. Herein, the second validator signature value is a signature value of the validator on a specific agenda generation.

Next, the content providing server 100 may transmit the specific agenda generation transaction information, including the specific agenda generation purpose information, the minimum voting quantity of the secondary stakable tokens, the cool time information, the cancel lock information and the second validator signature value, to the blockchain intermediary server 203 at a step of S309. Then, the blockchain intermediary server 203 may generate a specific agenda generation transaction by interacting with the blockchain network 400. Further, the blockchain intermediary server 203 may transmit the specific agenda generation result corresponding to the specific agenda generation transaction information to the content providing server 100 at a step of S310.

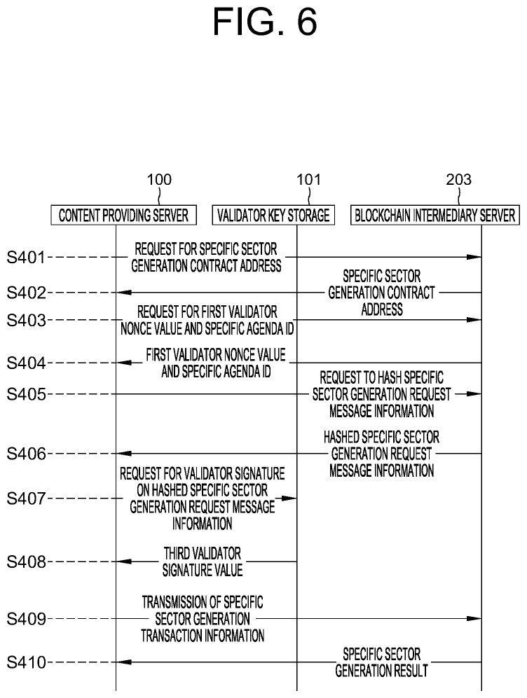

FIG. 6 is a drawing schematically illustrating a sequence diagram of generating and transmitting specific sector generation transaction information to the blockchain intermediary server in response to a generation request for the specific sector and thus transmitting a specific sector generation result to the content providing server in accordance with one example embodiment of the present disclosure.

By referring to FIG. 6, the content providing server 100 may transmit a request for a specific sector generation contract address to the blockchain intermediary server 203 at a step of S401. Then, the blockchain intermediary server 203 may transmit the specific sector generation contract address to the content providing server 100 at a step of S402.

In addition, the content providing server 100 may transmit a request for a first validator nonce value and the specific agenda ID to the blockchain intermediary server 203 at a step of S403 and acquire the first validator nonce value and the specific agenda ID from the blockchain intermediary server 203 at a step of S404. Herein, the first validator nonce value is a validator nonce value for generating the specific sector.

Next, the content providing server 100 may generate specific sector generation request message information, including the specific sector generation contract address, the specific agenda ID, the first validator nonce value, specific sector generation purpose information and specific sector account address, and transmit a request for hashing of the specific sector generation request message information to the blockchain intermediary server 203 at a step of S405. Herein, information on the specific sector account address is account address information of the specific sector, which is one of the 1-st sector to the n-th sector generated for the user to perform staking.

Then, the blockchain intermediary server 203 may transmit hashed specific sector generation request message information, generated by hashing the specific sector generation request message information, to the content providing server 100 at a step of S406.

Further, the content providing server 100 may transmit a request for a validator signature on the hashed specific sector generation request message information to the validator key storage 101 included in the content providing server 100 at a step of S407. Then, the validator key storage 101 may generate a third validator signature value by signing the hashed specific sector generation request message information with the validator private key and transmit the third validator signature value to the content providing server 100 at a step of S408. Herein, the third validator signature value is a validator signature value for generating the specific sector.

Next, the content providing server 100 may transmit the specific sector generation transaction information, including the specific agenda ID, the first validator nonce value, the specific sector generation purpose information, the specific sector account address and the third validator signature value, to the blockchain intermediary server 203 at a step of S409. Then, the blockchain intermediary server 203 may generate a specific sector generation transaction by interacting with the blockchain network 400. Following, the blockchain intermediary server 203 may transmit the specific sector generation result corresponding to the specific sector generation transaction information to the content providing server 100 at a step of S410.

FIG. 7 is a drawing schematically illustrating a sequence diagram of generating and transmitting sector change transaction information to the blockchain intermediary server in response to a sector change request and thus transmitting a sector change result to the content providing server in accordance with one example embodiment of the present disclosure.

By referring to FIG. 7, in order to change the specific sector to which the specific agenda is applied to another sector, the content providing server 100 may transmit a request for a sector change contract address to the blockchain intermediary server 203 at a step of S501. Then, the blockchain intermediary server 203 may transmit the sector change contract address to the content providing server 100 at a step of S502.

In addition, the content providing server 100 may transmit a request for a second validator nonce value and the specific agenda ID to the blockchain intermediary server 203 at a step of S503 and acquire the second validator nonce value and the specific agenda ID from the blockchain intermediary server 203 at a step of S504. Herein, the second validator nonce value is a validator nonce value for changing the sector.

Next, the content providing server 100 may generate sector change request message information, including the sector change contract address, the specific agenda ID, the second validator nonce value, another sector index corresponding to the another sector, sector change purpose information and another sector account address corresponding to the another sector, and transmit a request for hashing of the sector change request message information to the blockchain intermediary server 203 at a step of S505. Herein, information on the another sector account address is account address information of the another sector, which is one of the 1-st sector to the n-th sector generated for the user to perform staking.

Then, the blockchain intermediary server 203 may transmit hashed sector change request message information, generated by hashing the sector change request message information, to the content providing server 100 at a step of S506.

Further, the content providing server 100 may transmit a request for a validator signature on the hashed sector change request message information to the validator key storage 101 included in the content providing server 100 at a step of S507. Then, the validator key storage 101 may generate a fourth validator signature value by signing the hashed sector change request message information with the validator private key and transmit the fourth validator signature value to the content providing server 100 at a step of S508. Herein, the fourth validator signature value is a validator signature value for changing the sector.

Next, the content providing server 100 may transmit the sector change transaction information, including the specific agenda ID, the second validator nonce value, the sector change purpose information, the another sector index, the another sector account address and the fourth validator signature value, to the blockchain intermediary server 203 at a step of S509. Then, the blockchain intermediary server 203 may generate a sector change transaction by interacting with the blockchain network 400. Following, the blockchain intermediary server 203 may transmit the sector change result corresponding to the sector change transaction information to the content providing server 100 at a step of S510.

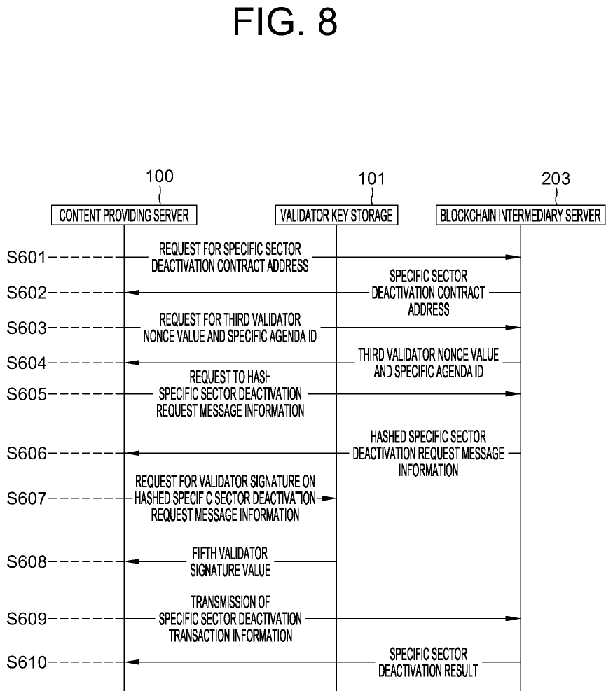

FIG. 8 is a drawing schematically illustrating a sequence diagram of generating and transmitting specific sector deactivation transaction information to the blockchain intermediary server in response to a specific sector deactivation request and thus transmitting a specific sector deactivation result to the content providing server in accordance with one example embodiment of the present disclosure.

First, deactivating the specific sector may mean, but is not limited to, deactivating the specific sector so that it no longer receives votes from the users after determining which sector (server) a specific agenda will be applied to.

By referring to FIG. 8, the content providing server 100 may transmit a request for a specific sector deactivation contract address to the blockchain intermediary server 203 at a step of S601. Then, the blockchain intermediary server 203 may transmit the specific sector deactivation contract address to the content providing server 100 at a step of S602.

In addition, the content providing server 100 may transmit a request for a third validator nonce value and the specific agenda ID to the blockchain intermediary server 203 at a step of S603 and acquire the third validator nonce value and the specific agenda ID from the blockchain intermediary server 203 at a step of S604. Herein, the third validator nonce value is a validator nonce value for deactivating the specific sector.

Next, the content providing server 100 may generate specific sector deactivation request message information, including the specific sector deactivation contract address, the specific agenda ID, the specific sector index and the third validator nonce value, and transmit a request for hashing of the specific sector deactivation request message information to the blockchain intermediary server 203 at a step of S605.

Then, the blockchain intermediary server 203 may transmit hashed specific sector deactivation request message information, generated by hashing the specific sector deactivation request message information, to the content providing server 100 at a step of S606.

Further, the content providing server 100 may transmit a request for a validator signature on the hashed specific sector deactivation request message information to the validator key storage 101 included in the content providing server 100 at a step of S607. Then, the validator key storage 101 may generate a fifth validator signature value by signing the hashed specific sector deactivation request message information with the validator private key and transmit the fifth validator signature value to the content providing server 100 at a step of S608. Herein, the fifth validator signature value is a validator signature value for deactivating the specific sector.

Next, the content providing server 100 may transmit the specific sector deactivation transaction information, including the specific agenda ID, the specific sector index, the third validator nonce value and the fifth validator signature value, to the blockchain intermediary server 203 at a step of S609. Then, the blockchain intermediary server 203 may generate a specific sector deactivation transaction by interacting with the blockchain network 400. Following, the blockchain intermediary server 203 may transmit the specific sector deactivation result corresponding to the specific sector deactivation transaction information to the content providing server 100 at a step of S610.

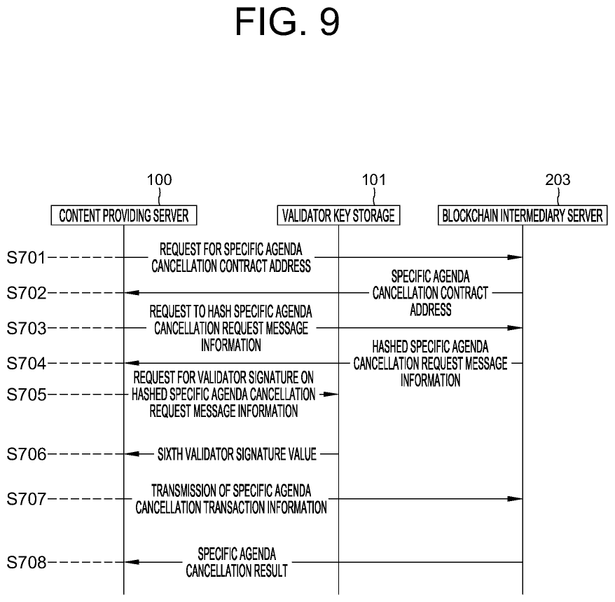

FIG. 9 is a drawing schematically illustrating a sequence diagram of generating and transmitting specific agenda cancellation transaction information to the blockchain intermediary server in response to a specific agenda cancellation request and thus transmitting a specific agenda cancellation result to the content providing server in accordance with one example embodiment of the present disclosure.

First, the specific agenda may be dropped if the specific sector or the voting result for the specific sector meets a predetermined condition. Herein, the predetermined condition may include, but is not limited to, dropping the specific agenda in response to detecting that there is no sector meeting a condition(s) for applying the specific agenda, for example, a condition of a minimum voting quantity of the sectors to apply the specific agenda.

By referring to FIG. 9, the content providing server 100 may transmit a request for a specific agenda cancellation contract address to the blockchain intermediary server 203 at a step of S701. Then, the blockchain intermediary server 203 may transmit the specific agenda cancellation contract address to the content providing server 100 at a step of S702.

In addition, the content providing server 100 may generate specific agenda cancellation request message information, including the specific agenda cancellation contract address and the specific agenda ID, and request the blockchain intermediary server 203 to hash the specific agenda cancellation request message information at a step of S703.

Then, the blockchain intermediary server 203 may transmit hashed specific agenda cancellation request message information, generated by hashing the specific agenda cancellation request message information, to the content providing server 100 at a step of S704.

In addition, the content providing server 100 may transmit a request for a validator signature on the hashed specific agenda cancellation request message information to the validator key storage 101 included in the content providing server 100 at a step of S705. Then, the validator key storage 101 may generate a sixth validator signature value by signing the hashed specific agenda cancellation request message information with the validator private key and transmit the sixth validator signature value to the content providing server 100 at a step of S706. Herein, the sixth validator signature value is a signature value of the validator on cancelling the specific agenda.

Next, the content providing server 100 may transmit the specific agenda cancellation transaction information, including the specific agenda ID and the sixth validator signature value, to the blockchain intermediary server 203 at a step of S707. Then, the blockchain intermediary server 203 may generate a specific agenda cancellation transaction by interacting with the blockchain network 400. Further, the blockchain intermediary server 203 may transmit the specific agenda cancellation result corresponding to the specific agenda cancellation transaction information to the content providing server 100 at a step of S708.

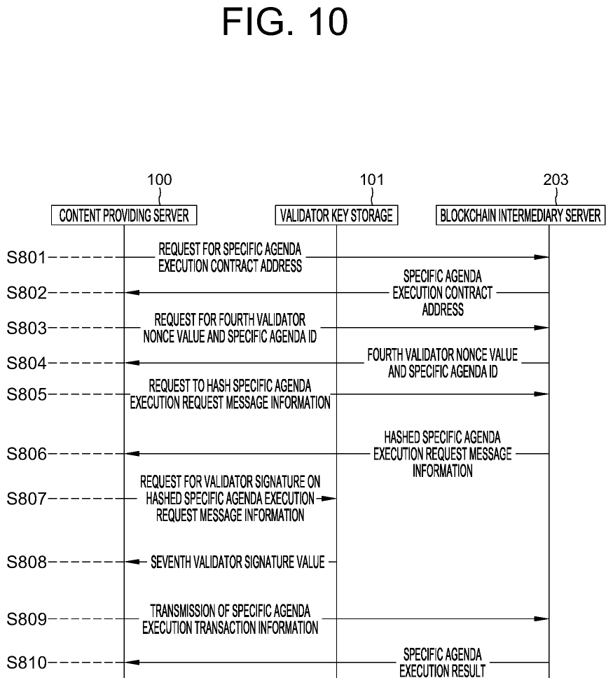

FIG. 10 is a drawing schematically illustrating a sequence diagram of generating and transmitting specific agenda execution transaction information to the blockchain intermediary server in response to a specific agenda execution request and thus transmitting a specific agenda execution result to the content providing server in accordance with one example embodiment of the present disclosure.

By referring to FIG. 10, the content providing server 100 may transmit a request for a specific agenda execution contract address to the blockchain intermediary server 203 at a step of S801. Then, the blockchain intermediary server 203 may transmit the specific agenda execution contract address to the content providing server 100 at a step of S802.

In addition, the content providing server 100 may transmit a request for a fourth validator nonce value and the specific agenda ID to the blockchain intermediary server 203 at a step of S803 and acquire the fourth validator nonce value and the specific agenda ID from the blockchain intermediary server 203 at a step of S804. Herein, the fourth validator nonce value is a validator nonce value for executing the specific agenda.

Next, the content providing server 100 may generate specific agenda execution request message information, including the specific agenda execution contract address, the specific agenda ID, the specific sector index and the fourth validator nonce value, and transmit a request for hashing of the specific agenda execution request message information to the blockchain intermediary server 203 at a step of S805.

Then, the blockchain intermediary server 203 may transmit hashed specific agenda execution request message information, generated by hashing the specific agenda execution request message information, to the content providing server 100 at a step of S806.

Further, the content providing server 100 may transmit a request for a validator signature on the hashed specific agenda execution request message information to the validator key storage 101 included in the content providing server 100 at a step of S807. Then, the validator key storage 101 may generate a seventh validator signature value by signing the hashed specific agenda execution request message information with the validator private key and transmit the seventh validator signature value to the content providing server 100 at a step of S808. Herein, the seventh validator signature value is a validator signature value for executing the specific agenda.

Next, the content providing server 100 may transmit the specific agenda execution transaction information, including the specific agenda ID, the specific sector index, the fourth validator nonce value and the seventh validator signature value, to the blockchain intermediary server 203 at a step of S809. Then, the blockchain intermediary server 203 may generate a specific agenda execution transaction by interacting with the blockchain network 400. Following, the blockchain intermediary server 203 may transmit the specific agenda execution result corresponding to the specific agenda execution transaction information to the content providing server 100 at a step of S810.

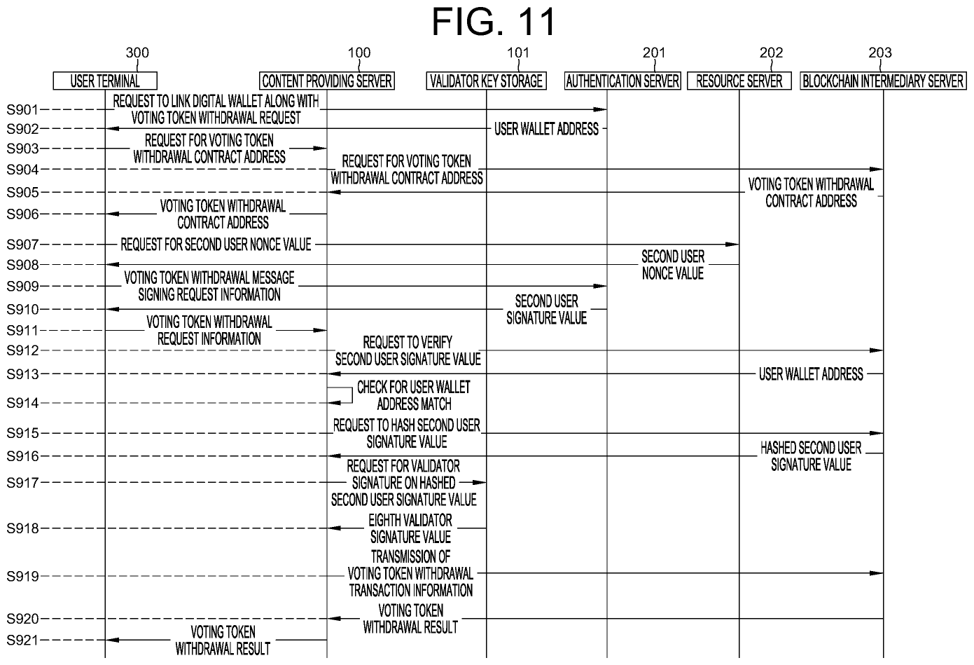

FIG. 11 is a drawing schematically illustrating a sequence diagram of generating and transmitting voting token withdrawal transaction information to the blockchain intermediary server in response to a voting token withdrawal request made by the user terminal and thus transmitting a voting token withdrawal result to the user terminal in accordance with one example embodiment of the present disclosure.

By referring to FIG. 11, the user terminal 300 may transmit a request for withdrawal of voting tokens, along with a request for linking of the electronic wallet, to the authentication server 201 included in the management server 200 at a step of S901. Then, the authentication server 201 may verify the user and then transmit the user wallet address to the user terminal 300 at a step of S902. Herein, the authentication server 201 may issue the access token, which is the authentication information on the user, to the user terminal 300 along with the user wallet address.

Also, the user terminal 300 may transmit a request for a voting token withdrawal contract address to the content providing server at a step of S903. Then, the content providing server 100 may transmit a request for the voting token withdrawal contract address to the blockchain intermediary server 203 at a step of S904, and in response, the blockchain intermediary server 203 may receive the voting token withdrawal contract address from the blockchain network 400 and transmit the voting token withdrawal contract address to the content providing server 100 at a step of S905. Following, the content providing server 100 may transmit the voting token withdrawal contract address, received from the blockchain intermediary server 203 to the user terminal 300 at a step of S906.

Further, the user terminal 300 may transmit a request for a second user nonce value to the resource server 202 included in the management server 200 at a step of S907. Herein, when requesting the second user nonce value to the resource server 202, the user terminal 300 may also transmit the access token acquired from the authentication server 201 to thereby allow the resource server 202 to verify the access token, and acquire the second user nonce value as a result of the verification thereof at a step of S908, but the present disclosure is not limited thereto.

Also, the user terminal 300 may generate voting token withdrawal message signature request information, including the voting token withdrawal contract address, the user wallet address, the specific agenda ID, the specific sector index corresponding to the specific agenda, a voting token withdrawal quantity and the second user nonce value, and transmit the voting token withdrawal message signature request information to the authentication server 201 of the management server 200 at a step of S909. Then, the authentication server 201 may generate a second user signature value by signing the voting token withdrawal message signature request information with the user private key and transmit the second user signature value to the user terminal at a step of S910.

Next, the user terminal 300 may transmit voting token withdrawal request information, including the voting token withdrawal contract address, the user wallet address, the specific agenda ID, the specific sector index, the voting token withdrawal quantity, the second user nonce value and the second user signature value, to the content providing server 100 at a step of S911. Then, the content providing server 100 may transmit the voting token withdrawal request information to the blockchain intermediary server 203 and transmit a request for verification of the second user signature value included in the voting token withdrawal request information to the blockchain intermediary server 203 at a step of S912.

At this time, the content providing server 100 may transmit the voting token withdrawal request information to the blockchain intermediary server 203 and thus instruct the blockchain intermediary server 203 to acquire the voting token withdrawal message signature request information by decrypting the second user signature value (included in the voting token withdrawal request information) with the user public key and transmit the user wallet address included in the voting token withdrawal message signature request information to the content providing server 100 at a step of S913. Then, the content providing server 100 may verify the second user signature value and the user wallet address by confirming that the user wallet address (included in the voting token withdrawal message signature request information acquired from the blockchain intermediary server 203) and the user wallet address (included in the voting token withdrawal request information acquired from the user terminal 300) match with each other at a step of S914, but the present disclosure is not limited thereto.

In addition, the content providing server 100 may transmit a request for hashing of the second user signature value to the blockchain intermediary server 203 at a step of S915. Then, the blockchain intermediary server 203 may transmit a hashed second user signature value, generated by hashing the second user signature value, to the content providing server 100 at a step of S916. Further, the content providing server 100 may transmit a request for a validator signature on the hashed second user signature value to the validator key storage 101 included in the content providing server 100 at a step of S917. Then, the validator key storage 101 may generate an eighth validator signature value by signing the second user signature value with the validator private key and transmit the eighth validator signature value to the content providing server 100 at a step of S918. Herein, the eighth validator signature value is a validator signature value for the process of withdrawing the voting tokens.

Next, the content providing server 100 may transmit voting token withdrawal transaction information, including the specific agenda ID, the user wallet address, the specific sector index, the voting token withdrawal quantity, the second user nonce value, the second user signature value and the eighth validator signature value, to the blockchain intermediary server 203 at a step of S919. Then, the blockchain intermediary server 203 may generate a voting token withdrawal transaction by interacting with the blockchain network 400. Afterwards, the content providing server 100 may acquire the voting token withdrawal result corresponding to the voting token withdrawal transaction information from the blockchain intermediary server 203 at a step of S920 and then transmit the voting token withdrawal result to the user terminal 300 at a step of S921.

The present disclosure has an effect of allowing the users to stake the primary stakable tokens to obtain the secondary stakable tokens as the reward tokens, allowing the users to perform votes on which hardware sector the specific agenda will be applied to by staking the secondary stakable tokens and providing the content by having the specific agenda applied to a specific hardware sector determined by the votes, thereby allowing the users who are interested in the specific agenda related to the content to gather in the specific hardware sector and increasing an energy efficiency of hardware.

The present disclosure has another effect of verifying information about the user in response to the voting request for the secondary stakable tokens from the user terminal, generating and transmitting voting transaction information to the blockchain intermediary server upon completion of verifying the information about the user, and transmitting the voting result corresponding to the voting transaction information to the user terminal.

The present disclosure has still another effect of transmitting the specific agenda generation transaction information and the specific sector generation transaction information to the blockchain intermediary server in response to requests for generating the specific agenda and the specific sector corresponding thereto from the content providing server and thus transmitting the specific agenda generation result and the specific sector generation result to the content providing server.

The present disclosure has still yet another effect of transmitting the specific agenda execution transaction information and the specific agenda cancellation transaction information to the blockchain intermediary server in response to requests for executing and cancelling the specific agenda from the content providing server and thus transmitting the specific agenda execution result and the specific agenda cancellation result to the content providing server.

The present disclosure has still yet another effect of transmitting the sector change transaction information and the specific sector deactivation transaction information to the blockchain intermediary server in response to requests for changing and deactivating the specific sector from the content providing server and thus transmitting the sector change result and the specific sector deactivation result to the content providing server.

Besides, the embodiments of the present disclosure as explained above can be implemented in a form of executable program command through a variety of computer means recordable to computer readable media. The computer readable media may store solely or in combination, program commands, data files, and data structures. The program commands recorded in the media may be components specially designed for the present disclosure or may be usable for a skilled human in a field of computer software. The computer readable media include, but are not limited to, magnetic media such as hard drives, floppy diskettes, magnetic tapes, memory cards, solid-state drives, USB flash drives, optical media such as CD-ROM and DVD, magneto-optical media such as floptical diskettes and hardware devices such as a read-only memory (ROM), a random access memory (RAM), and a flash memory specially designed to store and carry out program commands. Program commands may include not only a machine language code made by a compiler but also a high level code that can be used by an interpreter etc., which is executed by a computer. The aforementioned hardware device may work as more than a software module to perform the action of the present disclosure and they may do the same in the opposite case. The hardware device may include a processor such as a CPU or a GPU, combined with a memory device such as ROM or RAM to store the program commands, configured to execute the commands stored in the memory, and a communication part which can exchange signals with external devices. In addition, the hardware device may include a keyboard, a mouse, and any other external input device to receive commands prepared by developers.

As seen above, the present disclosure has been explained by specific matters such as detailed components, limited embodiments, and drawings. While the invention has been shown and described with respect to the preferred embodiments, it, however, will be understood by those skilled in the art that various changes and modification may be made without departing from the spirit and scope of the invention as defined in the following claims.

Accordingly, the thought of the present disclosure must not be confined to the explained embodiments, and the following patent claims as well as everything including variations equal or equivalent to the patent claims pertain to the category of the thought of the present disclosure.

What is claimed is:

1. A method for determining a specific event to be performed on a content based on results of votes obtained through staking of secondary stakable tokens having been acquired by staking primary stakable tokens, comprising steps of:
(a) on condition that (i) a management server has transmitted a user wallet address, a voting contract address and a first user nonce value to a user terminal in response to a voting request received from the user terminal, the voting request having been generated through the user terminal by staking the secondary stakable tokens, (ii) the user terminal has transmitted voting message signing request information, including the voting contract address, the user wallet address, a specific agenda ID, a specific sector index corresponding to a specific agenda, a voted quantity of the secondary stakable tokens and the first user nonce value, to the management server, wherein the specific sector index is an index value corresponding to a specific sector, among a 1-st sector to an n-th sector, on which a user of the user terminal intends to vote, and then (iii) the management server has transmitted a first user signature value, generated by signing the voting message signing request information with a user private key, to the user terminal, receiving, by a content providing server, voting request information, including the voting contract address, the user wallet address, the specific agenda ID, the specific sector index, the voted quantity of the secondary stakable tokens, the first user nonce value and the first user signature value, from the user terminal;
(b) (i) verifying, by the content providing server, the first user signature value included in the voting request information acquired from the user terminal, (ii) acquiring, by the content providing server, a hashed first user signature value by hashing the first user signature value upon completion of the process of verifying the first user signature value, and (iii) acquiring, by the content providing server, a first validator signature value by signing the hashed first user signature value with a validator private key; and
(c) transmitting, by the content providing server, voting transaction information, including the specific agenda ID, the user wallet address, the specific sector index, the voted quantity of the secondary stakable tokens, the first user nonce value, the first user signature value and the first validator signature value, to the management server, and then receiving, by the content providing server, a voting result corresponding to the voting transaction information from the management server, to thereby transmit the voting result to the user terminal.

2. The method of claim 1, wherein the secondary stakable tokens are reward tokens provided to the user by staking the primary stakable tokens, and
wherein, before the step of (a), the method further comprises a step of:
(a0) (i) on condition that (1) the management server has transmitted the user wallet address to the user terminal in response to a staking request for the primary stakable tokens from the user terminal, (2) the content providing server has transmitted first use permission request transaction information to be used for requesting permission to use the primary stakable tokens to the management server and then the management server has transmitted first hashed use permission request transaction information, generated by hashing the first use permission request transaction information, to the content providing server, (3) the content providing server has transmitted first staking request transaction information to the management server and then the management server has transmitted first hashed staking request transaction information, generated by hashing the first staking request transaction information, to the content providing server, and (4) the content providing server has transmitted the first hashed use permission request transaction information and the first hashed staking request transaction information to the user terminal, instructing, by the content providing server, the management server to (i-1) receive a signing request on the first hashed use permission request transaction information and the first hashed staking request transaction information, (i-2) generate a first specific user signature value by signing the first hashed use permission request transaction information and the first hashed staking request transaction information with a specific user key, and (i-3) transmit the first specific user signature value to the user terminal; (ii) on condition that (1) the user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the management server, instructing, by the content providing server, the management server to invoke a token management contract and execute a token use permission request function whose parameters include a token staking contract address and a staking quantity of the primary stakable tokens, to thereby receive primary stakable token use permission request processing information and transmit the primary stakable token use permission request processing information to the content providing server; (iii) on condition that the content providing server has transmitted second staking request transaction information, including the first hashed staking request transaction information and the first specific user signature value, to the management server, instructing, by the content providing server, the management server to invoke a token staking contract and execute a token staking function whose parameters include the staking quantity of the primary stakable tokens, to thereby receive primary stakable token staking processing information and transmit the primary stakable token staking processing information to the content providing server; and (iv) (iv-1) determining, by the content providing server, a quantity of the secondary stakable tokens to be distributed to the user terminal by referring to the primary stakable token staking processing information and (iv-2) granting, by the content providing server, a voting right for the specific event to be performed on the content to the user terminal by referring to a staking quantity of the secondary stakable tokens.

3. The method of claim 1, wherein the secondary stakable tokens are reward tokens given to the user by staking a-th primary stakable tokens and b-th primary stakable tokens, both of which are among the first primary tokens, and
wherein, before the step of (a), the method further comprises a step of:
(a1) (i) on condition that (1) the management server has transmitted the user wallet address to the user terminal in response to a staking request for at least one of the primary stakable tokens among the a-th primary stakable tokens and the b-th primary stakable tokens from the user terminal, (2) the content providing server has transmitted first use permission request transaction information to be used for requesting permission to use the primary stakable tokens to the management server and then the management server has transmitted first hashed use permission request transaction information, generated by hashing the first use permission request transaction information, to the content providing server, (3) the content providing server has transmitted first staking request transaction information to the management server and then the management server has transmitted first hashed staking request transaction information, generated by hashing the first staking request transaction information, to the content providing server, and (4) the content providing server has transmitted the first hashed use permission request transaction information and the first hashed staking request transaction information to the user terminal, instructing, by the content providing server, the management server to (i-1) receive a signing request on the first hashed use permission request transaction information and the first hashed staking request transaction information from the user terminal, (i-2) generate a first specific user signature value by signing the first hashed use permission request transaction information and the first hashed staking request transaction information with a specific user key, and (i-3) transmit the first specific user signature value to the user terminal; (ii) on condition that (1) the user terminal has transmitted the first hashed use permission request transaction information, the first hashed staking request transaction information and the first specific user signature value to the content providing server, and (2) the content providing server has transmitted second use permission request transaction information, including the first hashed use permission request transaction information and the first specific user signature value, to the management server, instructing, by the content providing server, the management server to invoke a token management contract and execute a token use permission request function whose parameters include a token staking contract address and a staking quantity of the primary stakable token, to thereby receive primary stakable token use permission request processing information and transmit the primary stakable token use permission request processing information to the content providing server; (iii) on condition that the content providing server has transmitted second staking request transaction information, including the first hashed staking request transaction information and the first specific user signature value, to the management server, instructing, by the content providing server, the management server to invoke a token staking contract and execute a token staking function whose parameters include the staking quantity of the primary stakable token, to thereby receive primary stakable token staking processing information and transmit the primary stakable token staking processing information to the content providing server; and (iv) (iv-1) determining, by the content providing server, a quantity of the secondary stakable tokens to be distributed to the user terminal by referring to the primary stakable token staking processing information and (iv-2) granting, by the content providing server, a voting right for the specific event to be performed on the content to the user terminal by referring to a staking quantity of the secondary stakable tokens.

4. The method of claim 1, wherein, at the step of (a), the method further comprises a step of:
(a2) on condition that the management server has transmitted the user wallet address, linked to the user terminal, to the user terminal in response to receiving the voting request from the user terminal, (i) receiving, by the content providing server, request information for the voting contract address from the user terminal, (ii) transmitting, by the content providing server, the request information for the voting contract address to the management server and receiving, by the content providing server, the voting contract address corresponding to the request information from the management server to transmit the voting contract address to the user terminal, and (iii) on condition that the first user nonce value corresponding to the voting contract has been transmitted to the user terminal in response to a request for the first user nonce value from the user terminal, instructing, by the content providing server, the user terminal to generate the voting message signing request information, including the voting contract address, the user wallet address, the specific agenda ID, the specific sector index corresponding to the specific agenda, the voted quantity of the secondary stakable tokens and the first user nonce value.

5. The method of claim 4, wherein, before the step of (a2), the method further comprises a step of:
(a01) the content providing server (i) (i-1) receiving a specific agenda generation contract address from the management server by requesting information on the specific agenda generation contract address, corresponding to the specific agenda, to the management server and (i-2) receiving a previous agenda ID, which is most recently generated by requesting the previous agenda ID from the management server, (ii) (ii-1) generating specific agenda generation request message information, including the specific agenda generation contract address, the previous agenda ID, specific agenda generation purpose information corresponding to the specific agenda, a minimum voting quantity of the secondary stakable tokens, cool time information corresponding to the specific agenda and cancel lock information corresponding to the specific agenda, and (ii-2) acquiring hashed specific agenda generation request message information from the management server by requesting hashing of the specific agenda generation request message information to the management server, and (iii) (iii-1) acquiring a second validator signature value by signing the hashed specific agenda generation request message information with the validator private key and (iii-2) transmitting specific agenda generation transaction information, including the specific agenda generation purpose information, the minimum voting quantity of the secondary stakable tokens, the cool time information, the cancel lock information and the second validator signature value, to the management server to thereby receive a specific agenda generation result corresponding to the specific agenda generation transaction information from the management server.

6. The method of claim 5, further comprising a step of:
(a02) the content providing server (i) (i-1) receiving a specific sector generation contract address from the management server by requesting information on the specific sector generation contract address, corresponding to the specific sector index, to the management server and (i-2) receiving a first validator nonce value and the specific agenda ID by requesting the first validator nonce value and the specific agenda ID from the management server, (ii) (ii-1) generating specific sector generation request message information, including the specific sector generation contract address, the specific agenda ID, the first validator nonce value, specific sector generation purpose information and a specific sector account address, and (ii-2) acquiring hashed specific sector generation request message information from the management server by requesting hashing of the specific sector generation request message information to the management server, and (iii) (iii-1) acquiring a third validator signature value by signing the hashed specific sector generation request message information with the validator private key and (iii-2) transmitting specific sector generation transaction information, including the specific agenda ID, the first validator nonce value, the specific sector generation purpose information, the specific sector account address and the third validator signature value, to the management server to thereby receive a specific sector generation result corresponding to the specific sector generation transaction information from the management server.

7. The method of claim 6, wherein, at the step of (a02), in order to change the specific sector to which the specific agenda is applied to another sector, the method further comprises a step of:
the content providing server (i) (i-1) receiving a sector change contract address from the management server by requesting information on the sector change contract address to the management server and (i-2) receiving a second validator nonce value and the specific agenda ID by requesting the second validator nonce value and the specific agenda ID from the management server, (ii) (ii-1) generating sector change request message information, including the sector change contract address, the specific agenda ID, the second validator nonce value, another sector index corresponding to the another sector, sector change purpose information and another sector account address corresponding to the another sector, and (ii-2) acquiring hashed sector change request message information from the management server by requesting hashing of the sector change request message information to the management server and (iii) (iii-1) acquiring a fourth validator signature value by signing the hashed sector change request message information with the validator private key and (iii-2) transmitting sector change transaction information, including the specific agenda ID, the second validator nonce value, the sector change purpose information, the another sector index, the another sector account address and the fourth validator signature value, to the management server to thereby receive a sector change result corresponding to the sector change transaction information from the management server.

8. The method of claim 1, further comprising a step of:
(d) in order to deactivate the specific sector, the content providing server (i) (i-1) requesting information on a specific sector deactivation contract address corresponding to the specific sector index to the management server to thereby receive the specific sector deactivation contract address and (i-2) receiving a third validator nonce value and the specific agenda ID by requesting the third validator nonce value and the specific agenda ID from the management server, (ii) (ii-1) generating specific sector deactivation request message information, including the specific sector deactivation contract address, the specific agenda ID, the specific sector index and the third validator nonce value, and (ii-2) acquiring hashed specific sector deactivation request message information from the management server by requesting hashing of the specific sector deactivation request message information to the management server, and (iii) (iii-1) acquiring a fifth validator signature value by signing the hashed specific sector deactivation request message information with the validator private key and (iii-2) transmitting specific sector deactivation transaction information, including the specific agenda ID, the specific sector index, the third validator nonce value and the fifth validator signature value, to the management server to thereby receive a specific sector deactivation result corresponding to the specific sector deactivation transaction information from the management server.

9. The method of claim 1, further comprising a step of:
(e) in response to the specific sector or the voting result for the specific sector being determined to meet one or more predetermined conditions, the content providing server (i) (i-1) receiving a specific agenda cancellation contract address from the management server by requesting information on the specific agenda cancellation contract address corresponding to the specific agenda to the management server, (i-2) generating specific agenda cancellation request message information, including the specific agenda cancellation contract address and the specific agenda ID, and (i-3) acquiring hashed specific agenda cancellation request message information from the management server by requesting hashing of the specific agenda cancellation request message information to the management server, and (ii) (ii-1) acquiring a sixth validator signature value by signing the hashed specific agenda cancellation request message information with the validator private key and (ii-2) transmitting specific agenda cancellation transaction information, including the specific agenda ID and the sixth validator signature value, to the management server to thereby receive a specific agenda cancellation result corresponding to the specific agenda cancellation transaction information from the management server.

10. The method of claim 1, further comprising a step of:
(f) the content providing server (i) (i-1) determining the specific sector at which the specific agenda is to be executed, (i-2) receiving a specific agenda execution contract address from the management server by requesting information on the specific agenda execution contract address to the management server and (i-3) receiving a fourth validator nonce value and the specific agenda ID by requesting the fourth validator nonce value and the specific agenda ID from the management server, (ii) (ii-1) generating specific agenda execution request message information, including the specific agenda execution contract address, the specific agenda ID, the specific sector index and the fourth validator nonce value, and (ii-2) acquiring hashed specific agenda execution request message information from the management server by requesting hashing of the specific agenda execution request message information to the management server, and (iii) (iii-1) acquiring a seventh validator signature value by signing the hashed specific agenda execution request message information with the validator private key and (iii-2) transmitting specific agenda execution transaction information, including the specific agenda ID, the specific sector index, the fourth validator nonce value and the seventh validator signature value, to the management server to thereby receive a specific agenda execution result corresponding to the specific agenda execution transaction information from the management server.

11. The method of claim 1, wherein, at the step of (b), the content providing server transmits the voting request information to the management server and then instructs the management server to (i) acquire the voting message signing request information by decrypting the first user signature value included in the voting request information with a user public key and (ii) transmit the user wallet address included in the voting message signing request information to the content providing server, and
wherein the content providing server confirms whether the user wallet address, which is included in the voting message signing request information and transmitted from the management server, and the user wallet address, which is included in the voting request information and transmitted from the user terminal, match with each other, to thereby verify the first user signature value and the user wallet address.

12. The method of claim 1, further comprising a step of:
(g) on condition that (1) the management server has transmitted the user wallet address, a voting token withdrawal contract address and a second user nonce value to the user terminal in response to a voting token withdrawal request received from the user terminal, (2) the user terminal has transmitted voting token withdrawal message signature request information, including the voting token withdrawal contract address, the user wallet address, the specific agenda ID, the specific sector index, a voting token withdrawal quantity and the second user nonce value, to the management server, and then (3) the management server has transmitted a second user signature value, generated by signing the voting token withdrawal message signature request information with the user private key, to the user terminal, (i) receiving, by the content providing server, voting token withdrawal request information, including the voting token withdrawal contract address, the user wallet address, the specific agenda ID, the specific sector index, the voting token withdrawal quantity, the second user nonce value and the second user signature value, transmitted from the user terminal, (ii) (ii-1) performing, by the content providing server, a process of verifying the second user signature value included in the voting token withdrawal request information acquired from the user terminal, (ii-2) acquiring, by the content providing server, a hashed second user signature value by hashing the second user signature value upon completion of the process of verifying the second user signature value, and (ii-3) acquiring, by the content providing server, an eighth validator signature value by signing the hashed second user signature value with the validator private key, and (iii) transmitting, by the content providing server, voting token withdrawal transaction information, including the specific agenda ID, the user wallet address, the specific sector index, the voting token withdrawal quantity, the second user nonce value, the second user signature value and the eighth validator signature value, to the management server, and then receiving, by the content providing server, a voting token withdrawal result corresponding to the voting token withdrawal transaction information from the management server to thereby transmit the voting token withdrawal result to the user terminal.

13. A content providing server for determining a specific event to be performed on a content based on results of votes obtained through staking of secondary stakable tokens having been acquired by staking primary stakable tokens, comprising:
at least one memory that stores instructions; and
at least one processor configured to execute the instructions to perform or support another device to perform: (I) on condition that (i) a management server has transmitted a user wallet address, a voting contract address and a first user nonce value to a user terminal in response to a voting request received from the user terminal, the voting request having been generated through the user terminal by staking the secondary stakable tokens, (ii) the user terminal has transmitted voting message signing request information, including the voting contract address, the user wallet address, a specific agenda ID, a specific sector index corresponding to a specific agenda, a voted quantity of the secondary stakable tokens and the first user nonce value, to the management server, wherein the specific sector index is an index value corresponding to a specific sector, among a 1-st sector to an n-th sector, on which a user of the user terminal intends to vote, and then (iii) the management server has transmitted a first user signature value, generated by signing the voting message signing request information with a user private key, to the user terminal, a process of receiving voting request information, including the voting contract address, the user wallet address, the specific agenda ID, the specific sector index, the voted quantity of the secondary stakable tokens, the first user nonce value and the first user signature value, from the user terminal, (II) a process of (i) verifying the first user signature value included in the voting request information acquired from the user terminal, (ii) acquiring a hashed first user signature value by hashing the first user signature value upon completion of the process of verifying the first user signature value, and (iii) acquiring a first validator signature value by signing the hashed first user signature value with a validator private key, and (III) a process of transmitting voting transaction information, including the specific agenda ID, the user wallet address, the specific sector index, the voted quantity of the secondary stakable tokens, the first user nonce value, the first user signature value and the first validator signature value, to the management server, and then receiving a voting result corresponding to the voting transaction information from the management server, to thereby transmit the voting result to the user terminal.

14. The content providing server of claim 13, wherein the secondary stakable tokens are reward tokens provided to the user by staking the primary stakable tokens, and
wherein, before the process of (I), the processor further performs a process of:
(I-0) (i) on condition that (1) the management server has transmitted the user wallet address to the user terminal in response to a staking request for the primary stakable tokens from the user terminal, (2) the processor has transmitted first use permission request transaction information to be used for requesting permission to use the primary stakable tokens to the management server and then the management server has transmitted first hashed use permission request transaction information, generated by hashing the first use permission request transaction information, to the processor, (3) the processor has transmitted first staking request transaction information to the management server and then the management server has transmitted first hashed staking request transaction information, generated by hashing the first staking request transaction information, to the processor, and (4) the processor has transmitted the first hashed use permission request transaction information and the first hashed staking request transaction information to the user terminal, the processor instructing the management server to (i-1) receive a signing request on the first hashed use permission request transaction information and the first hashed staking request transaction information, (i-2) generate a first specific user signature value by signing the first hashed use permission request transaction information and the first hashed staking request transaction information with a specific user key, and (i-3) transmit the first specific user signature value to the user terminal, (ii) on condition that (1) the user terminal has transmitted the first hashed use permission request transaction information, the first hashed staking request transaction information and the first specific user signature value to the processor, and (2) the processor has transmitted second use permission request transaction information, including the first hashed use permission request transaction information and the first specific user signature value, to the management server, the processor instructing the management server to invoke a token management contract and execute a token use permission request function whose parameters include a token staking contract address and a staking quantity of the primary stakable tokens, to thereby receive primary stakable token use permission request processing information and transmit the primary stakable token use permission request processing information to the processor, (iii) on condition that the processor has transmitted second staking request transaction information, including the first hashed staking request transaction information and the first specific user signature value, to the management server, the processor instructing the management server to invoke a token staking contract and execute a token staking function whose parameters include the staking quantity of the primary stakable tokens, to thereby receive primary stakable token staking processing information and transmit the primary stakable token staking processing information to the processor, and (iv) (iv-1) the processor determining a quantity of the secondary stakable tokens to be distributed to the user terminal by referring to the primary stakable token staking processing information and (iv-2) the processor granting a voting right for the specific event to be performed on the content to the user terminal by referring to a staking quantity of the secondary stakable tokens.

15. The content providing server of claim 13, wherein the secondary stakable tokens are reward tokens given to the user by staking a-th primary stakable tokens and b-th primary stakable tokens, both of which are among the first primary tokens, and
wherein, before the process of (I), the processor further performs a process of:
(I-1) (i) on condition that (1) the management server has transmitted the user wallet address to the user terminal in response to a staking request for at least one of the primary stakable tokens among the a-th primary stakable tokens and the b-th primary stakable tokens from the user terminal, (2) the processor has transmitted first use permission request transaction information to be used for requesting permission to use the primary stakable tokens to the management server and then the management server has transmitted first hashed use permission request transaction information, generated by hashing the first use permission request transaction information, to the processor, (3) the processor has transmitted first staking request transaction information to the management server and then the management server has transmitted first hashed staking request transaction information, generated by hashing the first staking request transaction information, to the processor, and (4) the processor has transmitted the first hashed use permission request transaction information and the first hashed staking request transaction information to the user terminal, the processor instructing the management server to (i-1) receive a signing request on the first hashed use permission request transaction information and the first hashed staking request transaction information from the user terminal, (i-2) generate a first specific user signature value by signing the first hashed use permission request transaction information and the first hashed staking request transaction information with a specific user key, and (i-3) transmit the first specific user signature value to the user terminal, (ii) on condition that (1) the user terminal has transmitted the first hashed use permission request transaction information, the first hashed staking request transaction information and the first specific user signature value to the processor, and (2) the processor has transmitted second use permission request transaction information, including the first hashed use permission request transaction information and the first specific user signature value, to the management server, the processor instructing the management server to invoke a token management contract and execute a token use permission request function whose parameters include a token staking contract address and a staking quantity of the primary stakable token, to thereby receive primary stakable token use permission request processing information and transmit the primary stakable token use permission request processing information to the processor, (iii) on condition that the processor has transmitted second staking request transaction information, including the first hashed staking request transaction information and the first specific user signature value, to the management server, the processor instructing the management server to invoke a token staking contract and execute a token staking function whose parameters include the staking quantity of the primary stakable token, to thereby receive primary stakable token staking processing information and transmit the primary stakable token staking processing information to the processor, and (iv) (iv-1) the processor determining a quantity of the secondary stakable tokens to be distributed to the user terminal by referring to the primary stakable token staking processing information and (iv-2) the processor granting a voting right for the specific event to be performed on the content to the user terminal by referring to a staking quantity of the secondary stakable tokens.

16. The content providing server of claim 13, wherein, at the process of (I), the processor further performs a process of:
(I-2) on condition that the management server has transmitted the user wallet address, linked to the user terminal, to the user terminal in response to receiving the voting request from the user terminal, (i) the processor receiving request information for the voting contract address from the user terminal, (ii) the processor transmitting the request information for the voting contract address to the management server and the processor receiving the voting contract address corresponding to the request information from the management server to transmit the voting contract address to the user terminal, and (iii) on condition that the first user nonce value corresponding to the voting contract has been transmitted to the user terminal in response to a request for the first user nonce value from the user terminal, the processor instructing the user terminal to generate the voting message signing request information, including the voting contract address, the user wallet address, the specific agenda ID, the specific sector index corresponding to the specific agenda, the voted quantity of the secondary stakable tokens and the first user nonce value.

17. The content providing server of claim 16, wherein, before the process of (I-2), the processor further performs a process of:
(I-01) the processor (i) (i-1) receiving a specific agenda generation contract address from the management server by requesting information on the specific agenda generation contract address, corresponding to the specific agenda, to the management server and (i-2) receiving a previous agenda ID, which is most recently generated by requesting the previous agenda ID from the management server, (ii) (ii-1) generating specific agenda generation request message information, including the specific agenda generation contract address, the previous agenda ID, specific agenda generation purpose information corresponding to the specific agenda, a minimum voting quantity of the secondary stakable tokens, cool time information corresponding to the specific agenda and cancel lock information corresponding to the specific agenda, and (ii-2) acquiring hashed specific agenda generation request message information from the management server by requesting hashing of the specific agenda generation request message information to the management server, and (iii) (iii-1) acquiring a second validator signature value by signing the hashed specific agenda generation request message information with the validator private key and (iii-2) transmitting specific agenda generation transaction information, including the specific agenda generation purpose information, the minimum voting quantity of the secondary stakable tokens, the cool time information, the cancel lock information and the second validator signature value, to the management server to thereby receive a specific agenda generation result corresponding to the specific agenda generation transaction information from the management server.

18. The content providing server of claim 17, wherein the processor further performs a process of:
(I-02) the processor (i) (i-1) receiving a specific sector generation contract address from the management server by requesting information on the specific sector generation contract address, corresponding to the specific sector index, to the management server and (i-2) receiving a first validator nonce value and the specific agenda ID by requesting the first validator nonce value and the specific agenda ID from the management server, (ii) (ii-1) generating specific sector generation request message information, including the specific sector generation contract address, the specific agenda ID, the first validator nonce value, specific sector generation purpose information and a specific sector account address, and (ii-2) acquiring hashed specific sector generation request message information from the management server by requesting hashing of the specific sector generation request message information to the management server, and (iii) (iii-1) acquiring a third validator signature value by signing the hashed specific sector generation request message information with the validator private key and (iii-2) transmitting specific sector generation transaction information, including the specific agenda ID, the first validator nonce value, the specific sector generation purpose information, the specific sector account address and the third validator signature value, to the management server to thereby receive a specific sector generation result corresponding to the specific sector generation transaction information from the management server.

19. The content providing server of claim 18, wherein, at the process of (I-02), in order to change the specific sector to which the specific agenda is applied to another sector, the processor further performs a process of:
the processor (i) (i-1) receiving a sector change contract address from the management server by requesting information on the sector change contract address to the management server and (i-2) receiving a second validator nonce value and the specific agenda ID by requesting the second validator nonce value and the specific agenda ID from the management server, (ii) (ii-1) generating sector change request message information, including the sector change contract address, the specific agenda ID, the second validator nonce value, another sector index corresponding to the another sector, sector change purpose information and another sector account address corresponding to the another sector, and (ii-2) acquiring hashed sector change request message information from the management server by requesting hashing of the sector change request message information to the management server and (iii) (iii-1) acquiring a fourth validator signature value by signing the hashed sector change request message information with the validator private key and (iii-2) transmitting sector change transaction information, including the specific agenda ID, the second validator nonce value, the sector change purpose information, the another sector index, the another sector account address and the fourth validator signature value, to the management server to thereby receive a sector change result corresponding to the sector change transaction information from the management server.

20. The content providing server of claim 13, further performing a process of:
(IV) in order to deactivate the specific sector, the processor (i) (i-1) requesting information on a specific sector deactivation contract address corresponding to the specific sector index to the management server to thereby receive the specific sector deactivation contract address and (i-2) receiving a third validator nonce value and the specific agenda ID by requesting the third validator nonce value and the specific agenda ID from the management server, (ii) (ii-1) generating specific sector deactivation request message information, including the specific sector deactivation contract address, the specific agenda ID, the specific sector index and the third validator nonce value, and (ii-2) acquiring hashed specific sector deactivation request message information from the management server by requesting hashing of the specific sector deactivation request message information to the management server, and (iii) (iii-1) acquiring a fifth validator signature value by signing the hashed specific sector deactivation request message information with the validator private key and (iii-2) transmitting specific sector deactivation transaction information, including the specific agenda ID, the specific sector index, the third validator nonce value and the fifth validator signature value, to the management server to thereby receive a specific sector deactivation result corresponding to the specific sector deactivation transaction information from the management server.

21. The content providing server of claim 13, further performing a process of:
(V) in response to the specific sector or the voting result for the specific sector being determined to meet one or more predetermined conditions, the processor (i) (i-1) receiving a specific agenda cancellation contract address from the management server by requesting information on the specific agenda cancellation contract address corresponding to the specific agenda to the management server, (i-2) generating specific agenda cancellation request message information, including the specific agenda cancellation contract address and the specific agenda ID, and (i-3) acquiring hashed specific agenda cancellation request message information from the management server by requesting hashing of the specific agenda cancellation request message information to the management server, and (ii) (ii-1) acquiring a sixth validator signature value by signing the hashed specific agenda cancellation request message information with the validator private key and (ii-2) transmitting specific agenda cancellation transaction information, including the specific agenda ID and the sixth validator signature value, to the management server to thereby receive a specific agenda cancellation result corresponding to the specific agenda cancellation transaction information from the management server.

22. The content providing server of claim 13, further performing a process of:
(VI) the processor (i) (i-1) determining the specific sector at which the specific agenda is to be executed, (i-2) receiving a specific agenda execution contract address from the management server by requesting information on the specific agenda execution contract address to the management server and (i-3) receiving a fourth validator nonce value and the specific agenda ID by requesting the fourth validator nonce value and the specific agenda ID from the management server, (ii) (ii-1) generating specific agenda execution request message information, including the specific agenda execution contract address, the specific agenda ID, the specific sector index and the fourth validator nonce value, and (ii-2) acquiring hashed specific agenda execution request message information from the management server by requesting hashing of the specific agenda execution request message information to the management server, and (iii) (iii-1) acquiring a seventh validator signature value by signing the hashed specific agenda execution request message information with the validator private key and (iii-2) transmitting specific agenda execution transaction information, including the specific agenda ID, the specific sector index, the fourth validator nonce value and the seventh validator signature value, to the management server to thereby receive a specific agenda execution result corresponding to the specific agenda execution transaction information from the management server.

23. The content providing server of claim 13, wherein, at the process of (II), the processor transmits the voting request information to the management server and then instructs the management server to (i) acquire the voting message signing request information by decrypting the first user signature value included in the voting request information with a user public key and (ii) transmit the user wallet address included in the voting message signing request information to the processor, and
wherein the processor confirms whether the user wallet address, which is included in the voting message signing request information and transmitted from the management server, and the user wallet address, which is included in the voting request information and transmitted from the user terminal, match with each other, to thereby verify the first user signature value and the user wallet address.

24. The content providing server of claim 13, further performing a process of:
(VII) on condition that (1) the management server has transmitted the user wallet address, a voting token withdrawal contract address and a second user nonce value to the user terminal in response to a voting token withdrawal request received from the user terminal, (2) the user terminal has transmitted voting token withdrawal message signature request information, including the voting token withdrawal contract address, the user wallet address, the specific agenda ID, the specific sector index, a voting token withdrawal quantity and the second user nonce value, to the management server, and then (3) the management server has transmitted a second user signature value, generated by signing the voting token withdrawal message signature request information with the user private key, to the user terminal, (i) the processor receiving voting token withdrawal request information, including the voting token withdrawal contract address, the user wallet address, the specific agenda ID, the specific sector index, the voting token withdrawal quantity, the second user nonce value and the second user signature value, transmitted from the user terminal, (ii) (ii-1) the processor performing a process of verifying the second user signature value included in the voting token withdrawal request information acquired from the user terminal, (ii-2) the processor acquiring a hashed second user signature value by hashing the second user signature value upon completion of the process of verifying the second user signature value, and (ii-3) the processor acquiring an eighth validator signature value by signing the hashed second user signature value with the validator private key, and (iii) the processor transmitting voting token withdrawal transaction information, including the specific agenda ID, the user wallet address, the specific sector index, the voting token withdrawal quantity, the second user nonce value, the second user signature value and the eighth validator signature value, to the management server, and then the processor receiving a voting token withdrawal result corresponding to the voting token withdrawal transaction information from the management server to thereby transmit the voting token withdrawal result to the user terminal.
